(19) United States
(12) Patent Application Publication
(10) Pub. No.: US 2011/0193941 A1
(43) Pub. Date: Aug. 11, 2011

(54) IMAGE PROCESSING APPARATUS, IMAGING APPARATUS, IMAGE PROCESSING METHOD, AND PROGRAM

(75) Inventors: Seijiro INABA, Kanagawa (JP); Ryota Kosakai, Tokyo (JP)

(73) Assignee: Sony Corporation, Tokyo (JP)

(21) Appl. No.: 13/007,115

(22) Filed: Jan. 14, 2011

(30) Foreign Application Priority Data
Feb. 5, 2010 (JP) 2010-024016

(51) Int. Cl. H04N 13/02; G06K 9/00

(52) U.S. Cl. 348/46; 382/154; 348/E13.074

(57) ABSTRACT

An image processing apparatus includes an image evaluation unit evaluating properness of synthesized images as the 3-dimensional images. The image evaluation unit performs the process of evaluating the properness through analysis of a block correspondence difference vector calculated by subtracting a global motion vector indicating movement of an entire image from a block motion vector which is a motion vector of a block unit of the synthesized images, compares a predetermined threshold value to one of a block area of a block having the block correspondence difference vector and a movement amount additional value, and performs a process of determining that the synthesized images are not proper as the 3-dimensional images, when the block area is equal to or greater than a predetermined area threshold value or when the movement amount addition value is equal to or greater than a predetermined movement amount threshold value.

### BACKGROUND OF THE INVENTION

1. Field of the Invention

The present invention relates to an image processing apparatus, an imaging apparatus, an image processing method, and a program, and more specifically, to an image processing apparatus, an imaging apparatus, an image processing method, and a program capable of generating images to display 3-dimensional images (3D images) using a plurality of images photographed while a camera is moved.

2. Description of the Related Art

In order to generate 3-dimensional images (also referred to as 3D images or stereo images), it is necessary to photograph images at different observing points, that is, it is necessary to photograph left-eye images and right-eye images. Methods of photographing the images at the different observing points are broadly classified into two methods.

A first method is a method of using a so-called multi-lens camera capturing a subject simultaneously at different observing points using a plurality of camera units.

A second method is a method of using a so-called single lens camera capturing images continuously at different observing points using a single camera unit, while the imaging apparatus is moved.

For example, a multi-lens camera system used according to the first method has a configuration in which lenses are disposed at separate positions to photograph a subject simultaneously at the different observing points. However, the multi-lens camera system has a problem in that the camera system is expensive since the plurality of camera units is necessary.

On the contrary, a single lens camera system used according to the second method includes one camera unit as in a camera according to the related art. A plurality of images is photographed continuously at different observing points while a camera including one camera unit is moved and the plurality of photographed images is used to generate the 3-dimensional images.

Accordingly, when the single lens camera system is used, the system with one camera unit can be realized at a relatively low cost, as in a camera according to the related art.

In “Acquisition of Distance Information Using Omnidirectional Vision” (Journal of the Institute of Electronics, Information and Communication Engineers, D-II, Vol. J74-D-II, No. 4, 1991), a technique according to the related art describes a method of acquiring distance information on a subject from images photographed while a single lens camera is moved.

“Acquisition of Distance Information Using Omnidirectional Vision” (Journal of the Institute of Electronics, Information and Communication Engineers, D-II, Vol. J74-D-II, No. 4, 1991) describes the method of acquiring the distance information of a subject using two images obtained through two vertical slits by fixing a camera on the circumference placed at a given distance from the rotation center of a rotation table and photographing images continuously while rotating the rotation table.

As in “Acquisition of Distance Information Using Omnidirectional Vision” (Journal of the Institute of Electronics, Information and Communication Engineers, D-II, Vol. J74-D-II, No. 4, 1991), Japanese Unexamined Patent Application Publication No. 11-164326 discloses a configuration in which a left-eye panorama image and a right-eye panorama image applied to display the 3-dimensional images are acquired using two images obtained through two slits by installing a camera placed at a given distance from the rotation center of a rotation table and photographing images while the camera is rotated.

The plurality of techniques according to the related art discloses the method of acquiring the left-eye image and the right-eye image applied to display the 3-dimensional images using the images obtained through the slits when rotating the camera.

However, when the images are photographed sequentially by moving the single lens camera, a problem may arise in that the times at which the images are photographed are different. For example, when the left-eye image and the right-eye image are generated using two images obtained through the two slits by photographing the images while the camera is rotated, as described above, the times at which the same subject included in the left-eye image and the right-eye image is photographed may be sometimes different.

Therefore, when a subject is a car, a pedestrian, or the like which is moving, that is, a moving subject, the left-eye image and the right-eye image in which an erroneous amount of parallax of the moving subject different from that of a motionless object is set may be generated. That is, a problem may arise in that a 3-dimensionl (3D image/stereo) image having a proper sense of depth may not be supplied when a moving subject is included.

When the left-eye image and the right-eye image are generated, an image synthesis process of cutting and connecting parts (strips) of the images photographed at a plurality of different times is performed. However, in this case, when a subject distant from a camera and a subject close to the camera coexist, a problem may arise in that discontinuous portions occur in the connected parts of the image.

### SUMMARY OF THE INVENTION

It is desirable to provide an image processing apparatus, an imaging apparatus, an image processing method, and a program capable of determining properness of 3-dimensional images, for example, in a configuration in which a left-eye image and a right-eye image applied to display the 3-dimensional images are generated using images photographed sequentially by moving a single lens camera.

It is desirable to provide an image processing apparatus, an imaging apparatus, an image processing method, and a program capable of determining properness of 3-dimensional images, for example, by analyzing motion vectors from images in order to detect whether there is a photographed moving subject in the photographed images or detect whether a subject distant from a camera and a subject close to the camera coexist to determine the properness of the 3-dimensional images.

It is desirable to provide an image processing apparatus, an imaging apparatus, an image processing method, and a program capable of controlling a process of supplying evaluation information to a user who photographs images by evaluating the images by a properness determination process for 3-dimensional images, or a recording process in a medium in response to the determination result.

According to an embodiment of the invention, there is provided an image processing apparatus including an image evaluation unit evaluating properness of synthesized images, which are applied to display 3-dimensional images generated through a process of connecting strip regions cut from images photographed at different positions, as the 3-dimensional images. The image evaluation unit performs the process of evaluating the properness of the synthesized images as the 3-dimensional images through analysis of a block correspondence difference vector calculated by subtracting a global motion vector indicating movement of an entire image from a block motion vector which is a motion vector of a block unit of the synthesized images, compares a predetermined threshold value to at least one of (1) a block area (S) of a block having the block correspondence difference vector with a size equal to or larger than the predetermined threshold value and (2) a movement amount additional value (L) which is an additional value of a movement amount corresponding to a vector length of the block correspondence difference vector with the size equal to or larger than the predetermined threshold value, and performs a process of determining that the synthesized images are not proper as the 3-dimensional images, when the block area (S) is equal to or greater than a predetermined area threshold value or when the movement amount addition value (L) is equal to or greater than a predetermined movement amount threshold value.

In the image processing apparatus according to the embodiment of the invention, the image evaluation unit may set a weight according to a position of the block in the synthesized image, may calculate the block area (S) or the movement amount additional value (L) by multiplying a weight coefficient larger in a middle portion of the image, and may compare the result obtained by multiplying the weight coefficient to the threshold value.

In the image processing apparatus according to the embodiment of the invention, when calculating the block area (S) or the movement amount additional value (L), the image evaluation unit may calculate the block area (S) or the movement amount additional value (L) by performing a normalization process based on an image size of the synthesized image, and may compare the calculation result to the threshold value.

In the image processing apparatus according to the embodiment of the invention, the image evaluation unit may calculate a properness evaluation value A of the 3-dimensional image by Expression A=aΣ(α1)(S)+bΣ(α2) (L), where S is the block area, L is the movement amount additional value, α1 and α2 are the weight coefficient according to the position of the image, and a and b are balance adjustment weight coefficients of the block area (S) and the movement amount additional value (L).

In the image processing apparatus according to the embodiment of the invention, the image evaluation unit may generate a visualized image in which a difference vector corresponding to the synthesized image is indicated by the block unit, and may calculate the block area (S) and the movement amount additional value (L) by applying the visualized image.

The image processing apparatus according to the embodiment of the invention may further include a movement amount detection unit inputting the photographed images and calculating the block motion vectors by a matching process for the photographed images with each other. The image evaluation unit may calculate the block area (S) or the movement amount additional value (L) by applying the block motion vectors calculated by the movement amount detection unit.

The image processing apparatus according to the embodiment of the invention may further include an image synthesis unit inputting the plurality of images photographed at different positions and generating synthesized images by connecting strip areas cut from the respective images. The image synthesis unit may generate a left-eye synthesized image applied to display a 3-dimensional image by a connection synthesis process of left-eye image strips set in each image and may generate a right-eye synthesized image applied to display a 3-dimensional image by a connection synthesis process of right-eye image strips set in each image. The image evaluation unit may evaluate whether the synthesized images generated by the image synthesis unit are proper as the 3-dimensional images.

The image processing apparatus according to the embodiment of the invention may further include a control unit outputting a warning, when the image evaluation unit determines that the synthesized images are not proper as the 3-dimensional images.

In the image processing apparatus according to the embodiment of the invention, when the image evaluation unit determines that the synthesized images are not proper as the 3-dimensional images, the control unit may suspend a recording process for the synthesized images in a recording medium and may perform the recording process under a condition that a recording request is input from a user in response to the output of the warning.

According to another embodiment of the invention, there is provided an imaging apparatus including: a lens unit applied to image photographing; an imaging element performing photoelectrical conversion on a photographed image; and an image processing unit performing the image processing.

According to still another embodiment of the invention, there is provided an image processing method performed by an image processing apparatus, including the step of evaluating, by an image evaluation unit, properness of synthesized images, which are applied to display 3-dimensional images generated through a process of connecting strip regions cut from images photographed at different positions, as the 3-dimensional images. In the step of evaluating the properness, the process of evaluating the properness of the synthesized images as the 3-dimensional images is performed through analysis of a block correspondence difference vector calculated by subtracting a global motion vector indicating movement of an entire image from a block motion vector which is a motion vector of a block unit of the synthesized images, a predetermined threshold value is compared to at least one of (1) a block area (S) of a block having the block correspondence difference vector with a size equal to or larger than the predetermined threshold value and (2) a movement amount additional value (L) which is an additional value of a movement amount corresponding to a vector length of the block correspondence difference vector with the size equal to or larger than the predetermined threshold value, and a process of determining that the synthesized images are not proper as the 3-dimensional images is performed when the block area (S) is equal to or greater than a predetermined area threshold value or when the movement amount addition value (L) is equal to or greater than a predetermined movement amount threshold value.

According to still another embodiment of the invention, there is provided a program causing an image processing apparatus to execute image processing, including the step of evaluating, by an image evaluation unit, properness of synthesized images, which are applied to display 3-dimensional images generated through a process of connecting strip regions cut from images photographed at different positions, as the 3-dimensional images. The step of evaluating the properness includes performing the process of evaluating the properness of the synthesized images as the 3-dimensional images through analysis of a block correspondence difference vector calculated by subtracting a global motion vector indicating movement of an entire image from a block motion vector which is a motion vector of a block unit of the synthesized images, and comparing a predetermined threshold value to at least one of (1) a block area (S) of a block having the block correspondence difference vector with a size equal to or larger than the predetermined threshold value and (2) a movement amount additional value (L) which is an additional value of a movement amount corresponding to a vector length of the block correspondence difference vector having the size equal to or larger than the predetermined threshold value, and performing a process of determining that the synthesized images are not proper as the 3-dimensional images, when the block area (S) is equal to or greater than a predetermined area threshold value or when the movement amount addition value (L) is equal to or greater than a predetermined movement amount threshold value.

The program according to the embodiment of the invention is a program which can be supplied to, for example, an information processing apparatus or a computer system capable of executing various program codes from a recording medium or a communication medium supplied in a computer readable format. By supplying the program in the computer readable format, the processes are executed in accordance with the program on the information processing apparatus or the computer system.

The other goals, features, and advantages of the embodiments of the invention are clarified in the detailed description based on the embodiments of the invention and the accompanying drawings described below. The system in the specification has a logical collective configuration of a plurality of apparatuses and is not limited to a case where the apparatuses with each configuration are included in the same chassis.

According to the embodiments of the invention, there are provided the apparatus and method capable of evaluating the properness of the left-eye synthesized image and the right-eye synthesized image applied to display the 3-dimensional images generated by the strip regions cut from the plurality of images. The block correspondence difference vector calculated by subtracting the global motion vector indicating the movement of the entire image from the block motion vector which is the motion vector of the block unit of the synthesized images is analyzed. When the block area (S) having the block correspondence difference vector with the size equal to or greater than the predetermined threshold value or the movement amount additional value (L) which is a vector length additional value is equal to or larger the predetermined threshold value, it is determined that the synthesized images are not proper as the 3-dimensional images and a warning is output or recording control is performed in response to the determination result.

### BRIEF DESCRIPTION OF THE DRAWINGS

FIG. 1 is a diagram illustrating a process of generating a panorama image.

FIGS. 2A, 2B1, and 2B2 are diagrams illustrating a process of generating a left-eye image (L image) and a right-eye image (R image) applied to display a 3-dimensional (3D) image.

FIG. 3 is a diagram illustrating a principle of generating the left-eye image (L image) and the right-eye image (R image) applied to display the 3-dimensional (3D) image.

FIGS. 4A to 4C are diagrams illustrating an inversion model using a virtual imaging surface.

FIG. 5 is a diagram illustrating a model for a process of photographing a panorama image (3D panorama image).

FIG. 6 is a diagram illustrating an image photographed in the process of photographing the panorama image (3D panorama image) and an exemplary process of setting strips for a left-eye image and a right-eye image.

FIG. 7 is a diagram illustrating a process of connecting the strip regions and a process of generating a 3D left-eye synthesized image (3D panorama L image) and a 3D right-eye synthesized image (3D panorama R image).

FIGS. 8A and 8B are diagrams for describing the problems of a left-eye image and a right-eye image when a moving subject which is moving is included.

FIG. 9 is a diagram for describing problems when the range of the parallax of a subject included in the left-eye image and the right-eye image is too large, that is, “another subject with a large parallax” is included in parts of the images.

FIG. 10 is a diagram illustrating an exemplary configuration of an imaging apparatus which is an example of an image processing apparatus according to an embodiment of the invention.

FIG. 11 is a flowchart illustrating the order of the image photographing process and a synthesis process performed by the image processing apparatus according to the embodiment of the invention.

FIGS. 12A to 12D are diagrams for describing a generation example of a motion vector map and an image evaluation process when a moving subject is not included in an image.

FIGS. 13A to 13D are diagrams for describing a generation example of a motion vector map and an image evaluation process when a moving subject is included in an image.

FIGS. 14A to 14C are diagrams for describing a generation example of a motion vector map and an image evaluation process when “another subject with a large parallax” is included in an image.

FIGS. 15A to 15F are diagrams for describing an exemplary process on the images including a moving subject by the image evaluation unit.

FIG. 16 is a diagram for describing exemplary processing performed on the image including a moving subject by the image evaluation unit.

FIG. 17 is a diagram for describing exemplary setting of a weight according to the position of an image as the exemplary processing performed by the image evaluation unit.

FIG. 18 is a diagram illustrating exemplary processing performed by the image evaluation unit and an example of the image evaluation process to which a moving subject area (S) and a subject movement amount (L) are applied.

### DESCRIPTION OF THE PREFERRED EMBODIMENTS

Hereinafter, an image processing apparatus, an imaging apparatus, an image processing method, and a program according to an embodiment of the invention will be described with reference to the drawings. The description will be made in the following order.

1. Basic of Process of Generating Panorama Image and Generating 3-Dimensional (3D) Image

2. Problems in Generation of 3D Images Using Strip regions of Plurality of Images Photographed When Camera Is Moved

3. Exemplary Configuration of Imaging Processing Apparatus According to Embodiment of the Invention

4. Orders of Image Photographing Process and Image Processing Process

5. Principle of Properness Determination Process for 3-Dimensional Image Based on Motion Vector

6. Details of Image Evaluation Process in Image Evaluation Unit

### 1. Basic of Process of Generating Panorama Image and Generating 3-Dimensional (3D) Image

Left-eye images (L images) and right-eye images (R images) applied to display 3-dimensional (3D) images can be generated by connecting regions (strip regions) cut in a strip shape from images using the plurality of images continuously photographed while an imaging apparatus (camera) is moved. The embodiment of the invention has a configuration in which it is determined whether the images generated in the above process are proper as 3-dimensional images.

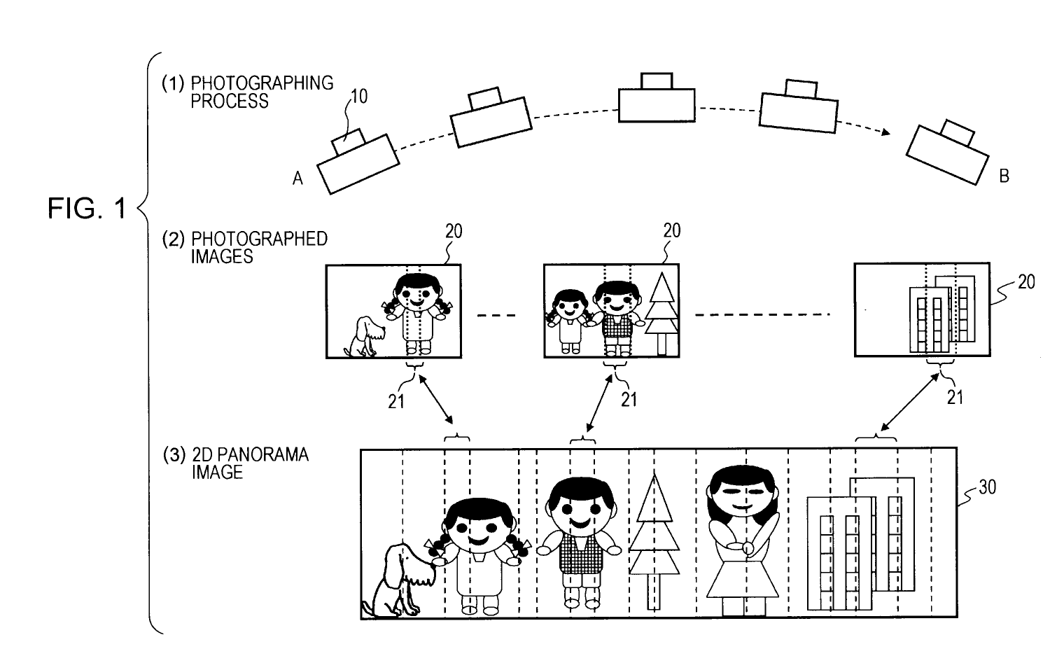

A camera capable of generating 2-dimensional panorama images (2D panorama images) using a plurality of images continuously photographed while the camera is moved is already in use. First, a process of generating panorama images (2D panorama images) as 2-dimensional synthesized images will be described with reference to FIG. 1. FIG. 1 is a diagram illustrating (1) a photographing process, (2) a photographed image, and (3) 2-dimensional synthesized images (2D panorama images).

A user sets a camera 10 to a panorama photographing mode and holds the camera 10 with his hands, and then presses down a shutter and moves the camera 10 from the left (point A) to the right (point B), as shown in Part (1) of FIG. 1. The camera 10 performs a continuous image photographing process when detecting that the user presses down the shutter in the panorama photographing mode. For example, the camera continuously photographs approximately several tens of images to about a hundred images.

These images are images 20 shown in Part (2) of FIG. 1. The plurality of images 20 are images continuously photographed while the camera 10 is moved and are images from different observing points. For example, the images 20 obtained by photographing 100 images from different observing points are sequentially recorded on a memory. A data processing unit of the camera 10 reads the plurality of images 20 shown in Part (2) of FIG. 1 from the memory, cuts strip regions to generate a panorama image from each image, performs a process of connecting the cut strip regions to generate a 2D panorama image 30 shown in Part (3) of FIG. 1.

The 2D panorama image 30 shown in Part (3) of FIG. 1 is a 2-dimensional (2D) image and is a horizontally long image obtained by cutting and connecting parts of the photographed images. Dot lines illustrated in Part (3) of FIG. 1 indicate image connected sections. A cutout region of each image 20 is called a strip region.

The image processing apparatus or the imaging apparatus according to an embodiment of the invention performs the image photographing process shown in Part (1) of FIG. 1, that is, properness evaluation on left-eye images (L images) and right-eye images (R images) applied to display 3-dimensional (3D) images using the plurality of images continuously photographed while the camera is moved, as shown in Part (1) of FIG. 1.

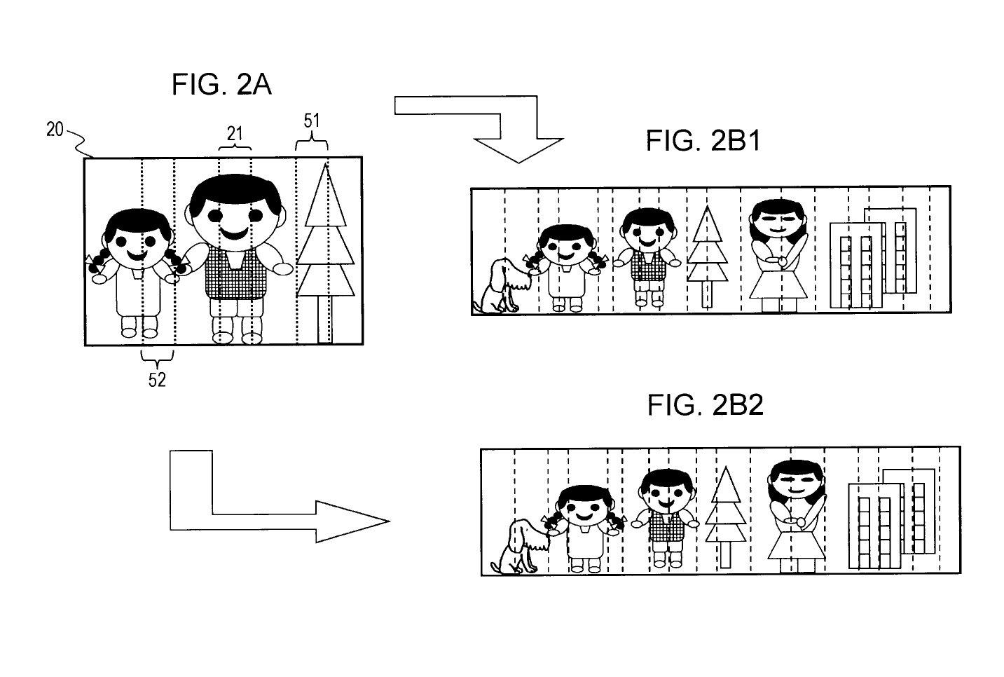

A basic of the process of generating the left-eye images (L images) and the right-eye images (R images) will be described with reference to FIGS. 2A, 2B1, and 2B2.

In FIG. 2A, one image 20 photographed in the panorama photographing process in Part (2) of FIG. 1 is shown.

Like the process of generating the 2D panorama image described with reference to FIG. 1, left-eye images (L images) and right-eye images (R images) applied to display a 3-dimensional (3D) image are generated by cutting and connecting predetermined strip regions from the image 20.

In this case, the left-eye images (L images) and the right-eye images (R images) are different from each other in the strip region which is the cutout region.

As shown in FIG. 2A, a left-eye image strip 51 (L image strip) and a right-eye image strip 52 (R image strip) are different from each other in the cutout position. In FIGS. 2A, 2B1, and 2B2, only one image 20 is shown, but the left-eye image strip (L image strip) and the right-eye image strip (R image strip) are set at different cutout positions in each of the plurality of images photographed while the camera is moved shown in Part (2) of FIG. 1.

Thereafter, the 3D left-eye panorama image (3D panorama L image) in FIG. 2B1 can be generated by collecting and connecting only the left-eye image strips (L image strip).

In addition, the 3D right-eye panorama image (3D panorama R image) in FIG. 2B2 can be generated by collecting and connecting only the right-eye image strips (R image strip).

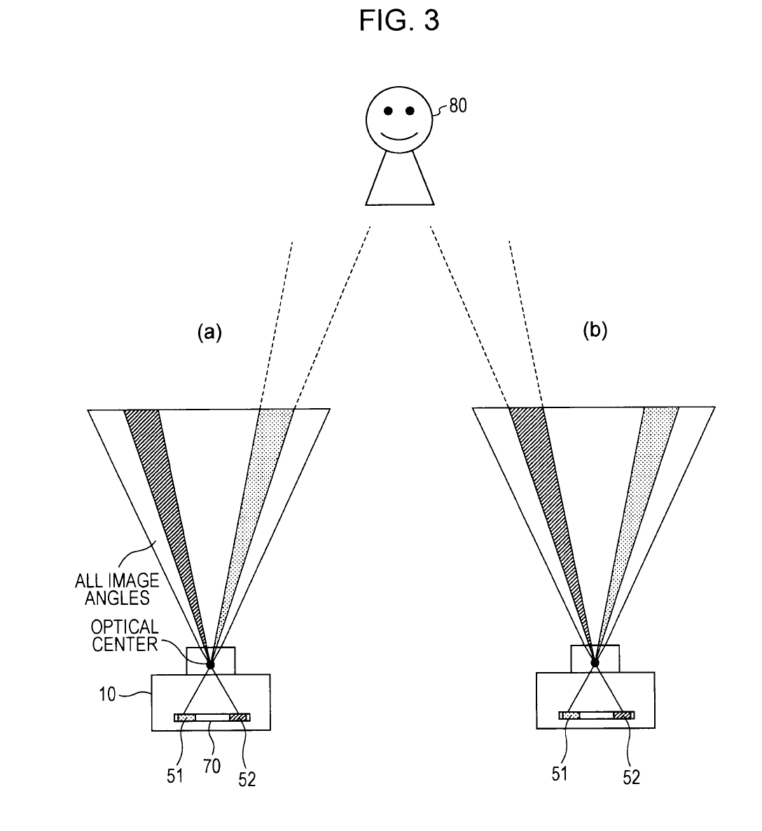

Thus, by connecting the strips set at different cutout positions in the plurality of images photographed while the camera is moved, the left-eye images (L images) and the right-eye images (R images) applied to display the 3-dimensional (3D) images can be generated. The principle of generating the left-eye images and the right-eye images will be described with reference to FIG. 3.

FIG. 3 is a diagram illustrating a state where the camera 10 is moved and placed at two photographing positions (a) and (b) to photograph a subject 80. As an image of the subject 80 at the position (a), an image observed from the left side is recorded in the left-eye image strip (L image strip) 51 of the imaging element 70 of the camera 10. Next, as an image of the subject 80 at the position (b) to which the camera 10 is moved, an image observed from the right side is recorded in the right-eye image strip (R image strip) 52 of the imaging element 70 of the camera 10.

In this way, the images obtained by observing the same subject at the different observing points are recorded in predetermined regions (strip regions) of the imaging element 70.

By extracting the images individually, that is, by collecting and connecting only the left-eye image strips (L image strips), the 3D left-eye panorama image (3D panorama L image) in FIG. 2B1 is generated. In addition, by collecting and connecting only the right-eye image strips (R image strips), the 3D right-eye panorama image (3D panorama R image) in FIG. 2B2 is generated.

In FIG. 3, the camera 10 is moved from the left side to the right side relative to the subject 80 in a cross manner to facilitate comprehension. However, it is not necessary that the camera 10 is moved relative to the subject 80 in a cross manner. As long as the images are recorded in predetermined areas of the imaging element 70 of the camera 10 from different observing points, the left-eye image and the right-eye image applied to display the 3D images can be generated.

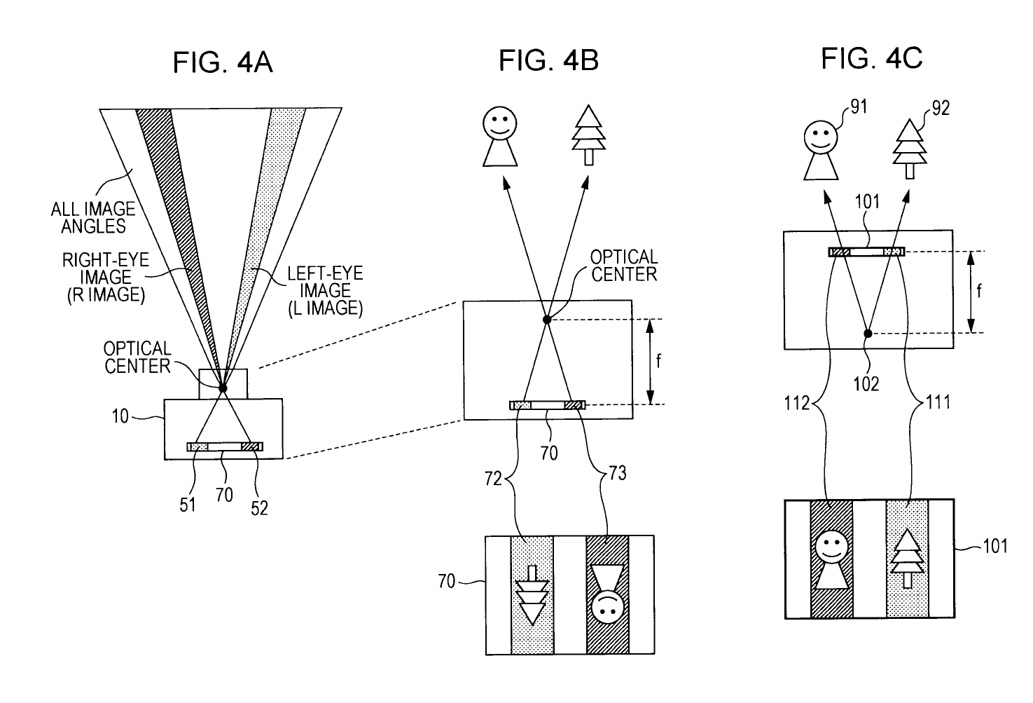

Next, an inversion model using a virtual imaging surface to be applied will be described below with reference to FIGS. 4A to 4C. FIGS. 4A to 4C are diagrams illustrating an imaging configuration, a normal model, and an inversion model, respectively.

In the imaging photographing configuration illustrated in FIG. 4A, a processing configuration when the same panorama image as that described with reference to FIG. 3 is photographed is shown.

In FIG. 4B, an exemplary image photographed by the imaging element 70 of the camera 10 in the photographing process shown in FIG. 4A is shown.

In the imaging element 70, a left-eye image 72 and a right-eye image 73 are vertically inverted and recorded, as shown in FIG. 4B. Since it is difficult to make description using the inverted image, the inversion model shown in FIG. 4C will be described below.

The inversion model is a model that is frequently used to describe an image of an imaging apparatus.

In the inversion model shown in FIG. 4C, it is assumed that a virtual imaging element 101 is set in the front of an optical center 102 corresponding to the focus of the camera and a subject image is photographed on the virtual imaging element 101. As shown in FIG. 4C, a subject A91 on the front left side of the camera is photographed on the left of the virtual imaging element 101 and a subject B92 on the front right side of the camera is photographed on the right of the virtual imaging element 101 and the subjects are set not to be vertically inverted, thereby reflecting the positional relationship of the actual subjects without inversion. That is, the images on the virtual imaging element 101 are the same image data as the actually photographed image data.

The description will be made below using the inversion model using the virtual imaging element 101.

However, as shown in FIG. 4C, on the virtual imaging element 101, a left-eye image (L image) 111 is photographed on the right of the virtual imaging element 101 and a right-eye image (R image) 112 is photographed on the left of the virtual imaging element 101.

2. Problems in Generation of 3D Images Using Strip Regions of Plurality of Images Photographed when Camera is Moved

Next, problems in generation of the 3D images using the strip regions of a plurality of images photographed while the camera is moved will be described.

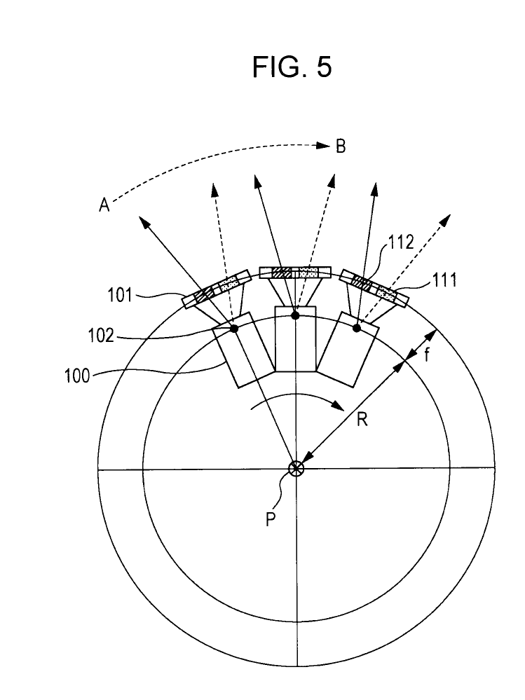

A photographing model shown in FIG. 5 is assumed as an exemplary model for a process of photographing a panorama image (3D panorama image). As shown in FIG. 5, the camera 100 is placed so that the optical center 102 of the camera 100 is set to be distant by a distance R (radius of rotation) from a rotational axis P which is a rotation center.

The virtual imaging surface 101 is set to be distant by a focal distance f from the optical center 102 and to be placed outside from the rotational axis P.

With such a configuration, the camera 100 is rotated clockwise (direction from A to B) about the rotational axis P to photograph a plurality of images continuously.

At each photographing point, an image of the left-eye image strip 111 and an image of the right-eye image strip 112 are recorded on the virtual imaging element 101.

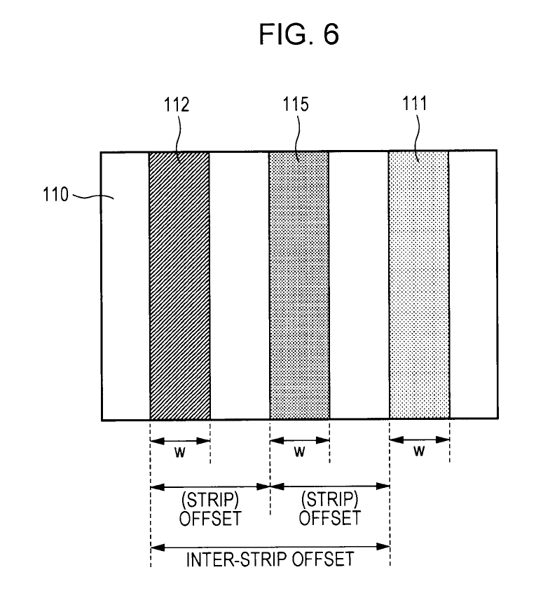

The recorded image has a structure shown in, for example, FIG. 6.

FIG. 6 is a diagram illustrating an image 110 photographed by the camera 100. The image 110 is the same as the image on the virtual imaging surface 101.

In the image 110, as shown in FIG. 6, a region (strip region) offset left from the center of the image and cut in a strip shape is referred to as the right-eye image strip 112 and a region (strip region) offset right from the center of the image and cut in a strip shape is referred to as the left-eye image strip 111.

In FIG. 6, a 2D panorama image strip 115 used to generate a 2-dimensional (2D) panorama image is shown as a reference.

As shown in FIG. 6, a distance between the 2D panorama image strip 115, which is a 2-dimensional synthesized image strip, and the left-eye image strip 111 and a distance between the 2D panorama image strip 115 and the right-eye image strip 112 are defined as an “offset” or a “strip offset”.

A distance between the left-eye image strip 111 and the right-eye image strip 112 is defined as an “inter-strip offset”.

An expression of inter-strip offset=(strip offset)×2 is satisfied.

A strip width w is a width w that is common to the 2D panorama image strip 115, the left-eye image strip 111, and the right-eye image strip 112. The strip width is varied depending on the movement speed of the camera. When the movement speed of the camera is fast, the strip width w is enlarged. When the movement speed of the camera is slow, the strip width w is narrowed.

The strip offset or the inter-strip offset can be set to have various values. For example, when the strip offset is large, the parallax between the left-eye image and the right-eye image becomes larger. When the strip offset is small, the parallax between the left-eye image and the right-eye image becomes smaller.

In a case of strip offset=0, a relation of left-eye image strip 111=right-eye image strip 112=2D panorama image strip 115 is satisfied.

In this case, a left-eye synthesized image (left-eye panorama image) obtained by synthesizing the left-eye image strip 111 and a right-eye synthesized image (right-eye panorama image) obtained by synthesizing the right-eye image strip 112 are exactly the same image, that is, become the same as the 2-dimensional panorama image obtained by synthesizing the 2D panorama image strip 115. Therefore, these images may not be used to display the 3-dimensional images.

The data processing unit of the camera 100 connects the strip regions cut from the respective images by calculating motion vectors between the images photographed continuously while the camera 100 is moved and sequentially determining the strip regions cut from the respective images while the positions of the strip regions are aligned to connect the patterns of the above-described strip regions.

That is, the left-eye synthesized image (left-eye panorama image) is generated by selecting, connecting, and synthesizing only the left-eye image strips 111 from the respective images and the right-eye synthesized image (right-eye panorama image) is generated by selecting, connecting, and synthesizing only the right-eye image strips 112 from the respective images.

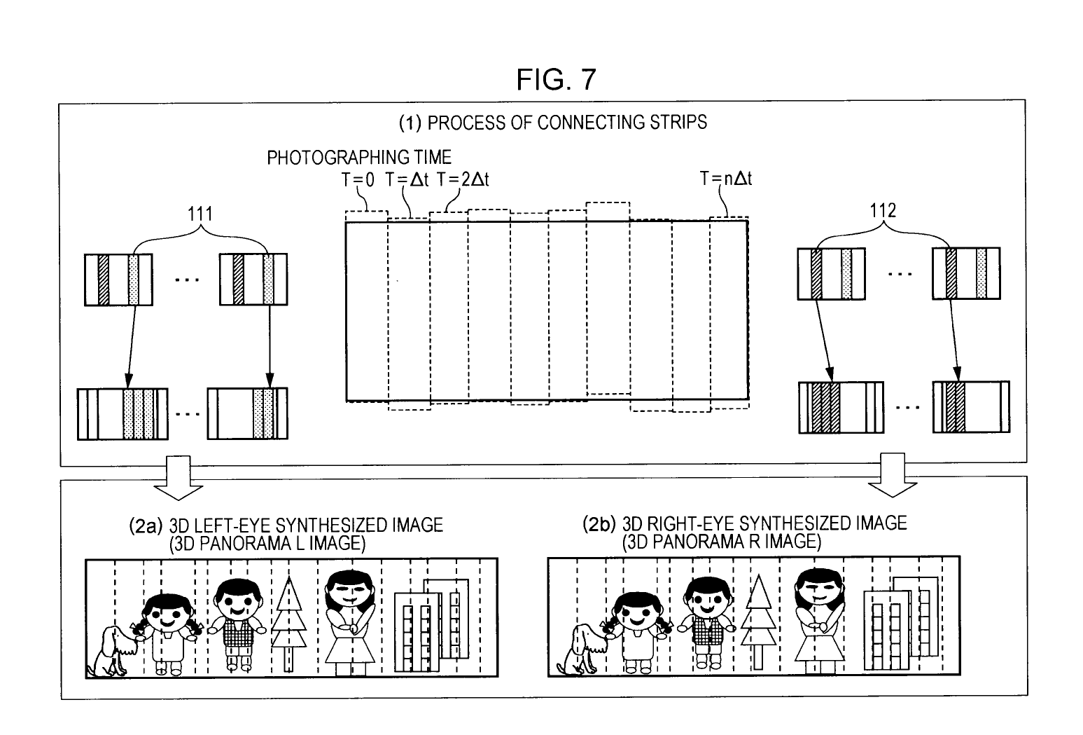

Part (1) of FIG. 7 is a diagram illustrating a process of connecting the strip regions. It is assumed that a photographing time interval of each image is Δt and n+1 images are photographed during T=0 to nΔt. The strip regions extracted from the n+1 images are connected to each other.

When the 3D left-eye synthesized image (3D panorama L image) is generated, only the left-eye image strips (L image strips) 111 are extracted and connected to each other. When the 3D right-eye synthesized image (3D panorama R image) is generated, only the right-eye image strips (R image strips) 112 are extracted and connected to each other.

The 3D left-eye synthesized image (3D panorama L image) in Part (2a) of FIG. 7 is generated by collecting and connecting only the left-eye image strips (L image strips) 111.

In addition, the 3D right-eye synthesized image (3D panorama R image) in Part (2b) of FIG. 7 is generated by collecting and connecting only the right-eye image strips (R image strips) 112.

The 3D left-eye synthesized image (3D panorama L image) in Part (2a) of FIG. 7 is generated by joining the strip regions offset right from the center of the image 100, as described with reference to FIGS. 6 and 7.

The 3D right-eye synthesized image (3D panorama R image) in Part (2b) of FIG. 7 is generated by joining the strip regions offset left from the center of the image 100.

Basically the same subject is captured on the two images, as described above with reference to FIG. 3. However, a parallax occurs since the same subject is photographed at the different positions. When the two images having the parallax are shown on a display apparatus capable of displaying a 3D (stereo) image, the photographed subject can be displayed 3-dimensionally.

In addition, there are various 3D display methods.

For example, the method includes a 3D image display method corresponding to a passive glasses method in which images observed by right and left eyes are separated by polarization filters or color filters or a 3D image display method corresponding to an active glasses method in which images observed by opening and closing a liquid crystal shutter alternately right and left are separated temporally in an alternate manner for right and left eyes.

The left-eye image and the right-eye image generated in the above-described process of connecting the strips are applicable to the above methods.

However, when the left-eye images and the right-eye images are generated by cutting the strip regions from the plurality of images photographed continuously while the camera 100 is moved, the photographing times of the same subject included in the left-eye images and the right-eye images may sometimes be different.

Therefore, when a subject, such as a car or a pedestrian, which is moving, that is, a moving subject, the left-eye image and the right-eye image in which an erroneous amount of parallax of the moving subject different from that of a motionless object is set may be generated. That is, a problem may arise in that when a moving subject is included, a 3-dimensional image (3D/stereo image) having a proper sense of depth may not be supplied.

Moreover, when the range of the parallax of the subjects included in the left-eye image or the right-eye image of the 3 dimensional image is too large, that is, when a subject distant from a camera and a subject close to the camera coexist, a problem may arise in that discontinuous portions occur in the connected parts of the image. Accordingly, even when “another subject having a large parallax” is included in a part of the image, a problem may arise in that a discontinuous portion occurs in the connected part of at least one of the near distant landscape and the far distant landscape in the image.

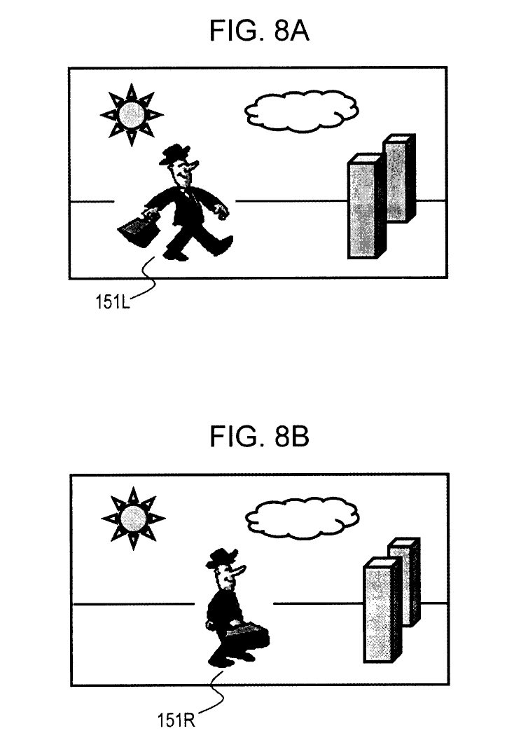

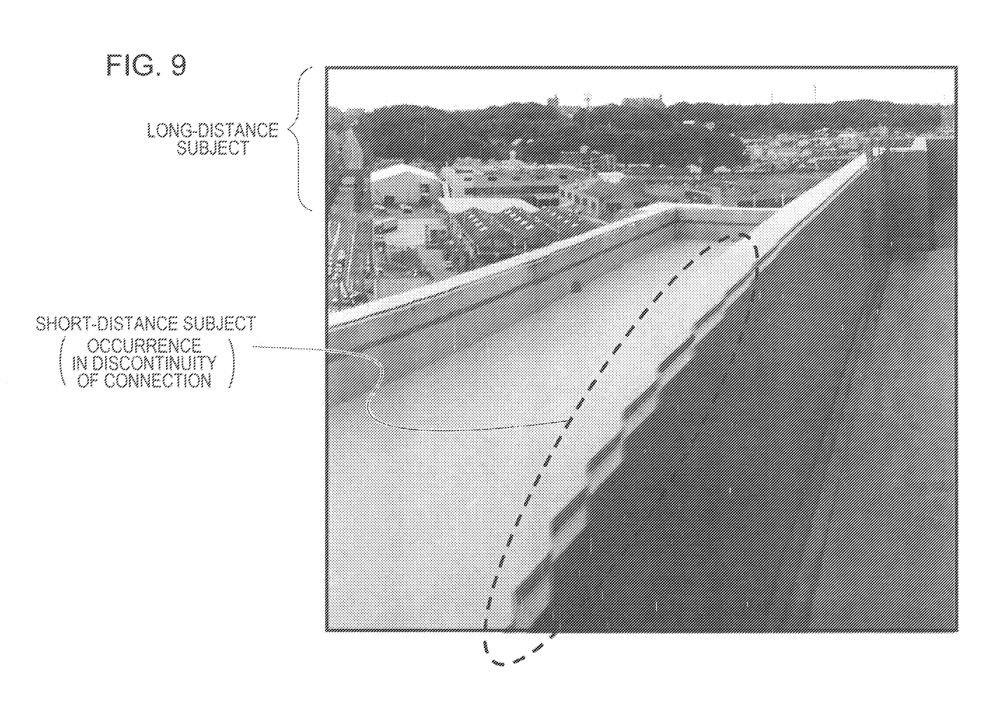

Hereinafter, this problem will be described with reference to FIGS. 8A, 8B, and 9.

In FIGS. 8A and 8B, a left-eye image and a right-eye image generated by cutting the strip regions from the plurality of image continuously photographed while a camera is moved are shown respectively.

Various subjects are captured on the two left-eye image (in FIG. 8A) and right-eye image (in FIG. 8B). A subject which is moving, that is, a moving subject (pedestrian) 151, is included among the subjects.

The moving subject (pedestrian) 151L included in the left-eye image (in FIG. 8A) and the moving subject (pedestrian) 151R included in the right-eye image (in FIG. 8B) are the same as each other, but are cut from the images photographed at different photographing times. Therefore, in the left-eye image (in FIG. 8A) and the right-eye image (in FIG. 8B), the images before the movement of the subject and after the movement of the subject are cut and set. Thus, the positional relation between the moving subject and the other fixed subject such as a building, a cloud, or the sun is clearly different.

As a consequence, the parallax corresponding to each distance between the left-eye image (in FIG. 8A) and the right-eye image (in FIG. 8B) is set for the building, the cloud, or the sun, thereby providing an appropriate sense of depth. However, a parallax different from the original parallax is set for the pedestrian 151 is set, thereby providing no appropriate sense of depth.

Thus, when a moving subject is included in a photographed image, the parallax of the moving subject may be set as an erroneous parallax different from the parallax that has to be set in the left-eye image and the right-eye image for an appropriate 3-dimensional image (3D image/stereo image). Therefore, no appropriate 3-dimensional image can be displayed.

For example, suppose a case in which an extremely close subject and a distant subject are photographed in one image when the rotational axis and the optical center of the imaging apparatus are not exactly aligned with each other. In this case, even when the strip regions of the continuously photographed images are connected and joined to each other, any one of the near distant landscape subject and the far distant landscape subject may sometimes not be connected well. This example will be described with reference to FIG. 9.

FIG. 9 is a diagram illustrating a synthesized image generated by connecting a plurality of continuously photographed images. In the image shown in FIG. 9, the extremely close subject (short-distance subject) and the distant subject (long-distance subject) are included.

In the image shown in FIG. 9, a far distant landscape (long-distance subject) is connected and joined properly when the strip regions of continuously photographed images are connected. However, the near distant landscape (short-distance subject) is not connected well. Discontinuous steps occur in the wall of the area of the near distant landscape.

This is because the parallax of the short-distance subject is greatly different from that of the long-distance subject. Thus, when “another subject having a large parallax” is included in a part of the image, a discontinuous image or the like may occur in the connected part of at least one of the near distant landscape and the far distant landscape in the image.

However, for example, when a user having a camera continuously photographs a plurality of images while the camera is moved, it is difficult to determine whether a moving subject is included while photographing the images or to determine whether a subject with a large parallax is included.

### 3. Exemplary Configuration of Imaging Processing Apparatus According to Embodiment of the Invention

Next, an image processing apparatus according to an embodiment of the invention which is capable of analyzing photographed images and determining whether the analyzed images are proper as images used to display 3-dimensional images in order to solve the above-mentioned problems will be described. The image processing apparatus according to the embodiment of the invention determines whether images are proper as 3-dimensional images of the synthesized images generated based on the photographed images. For example, the image processing apparatus determines whether there is a moving subject included in an image, performs image evaluation of the 3-dimensional images, and performs a process, such as control for image recording in a medium or warning to the user, based on the evaluation result. Hereinafter, an exemplary configuration and an exemplary process of the image processing apparatus according to the embodiment of the invention will be described.

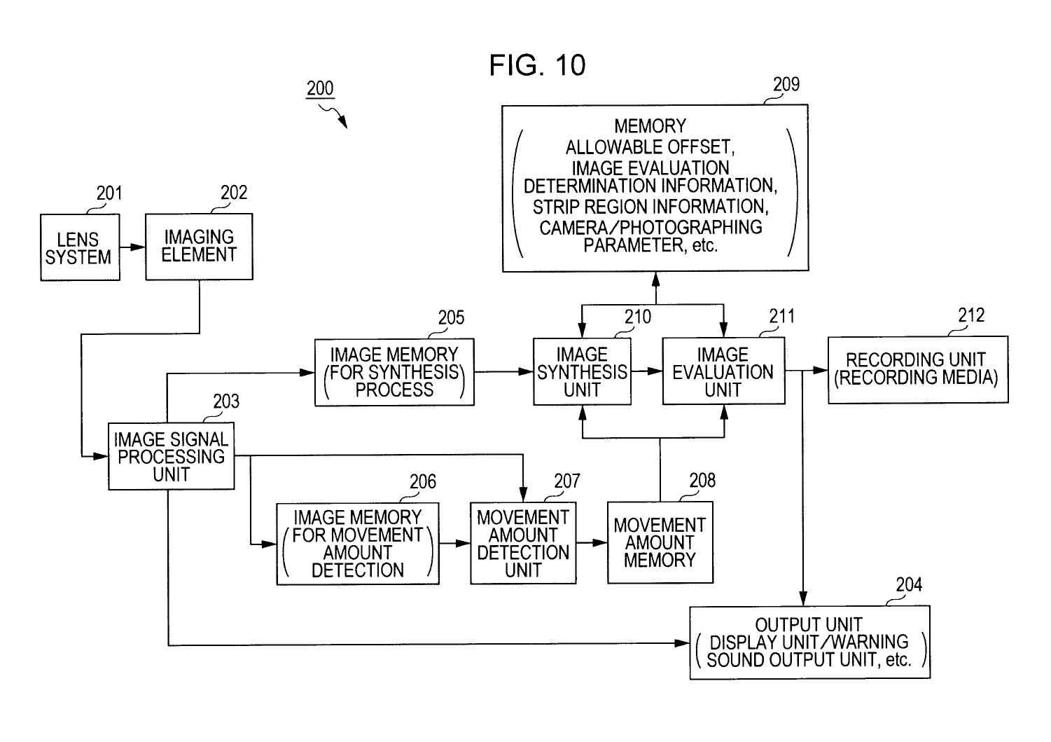

The exemplary configuration of an imaging apparatus 200 which is one example of the image processing apparatus according to the embodiment of the invention will be described with reference to FIG. 10.

The imaging apparatus 200 shown in FIG. 10 corresponding to the camera 10 described above with reference to FIG. 1. For example, a user holds the imaging apparatus with his hands and sets a mode such as a panorama photographing mode to photograph a plurality of images continuously.

Light from a subject is incident on an imaging element 202 through a lens system 201. The imaging element 202 is formed by, for example, a CCD (Charge Coupled Device) sensor or a CMOS (Complementary Metal Oxide Semiconductor) sensor.

The subject image incident on the imaging element 202 is transformed into an electric signal by the imaging element 202. Although not illustrated, the imaging element 202 including a predetermined signal processing circuit converts the converted electric signal into digital image data and supplies the converted digital image data to an image signal processing unit 203.

The image signal processing unit 203 performs image signal processing such as gamma correction or contour enhancement correction and displays an image signal as the signal processing result on a display unit 204. The image signal processed by the image signal processing unit 203 is supplied to units such as an image memory (for the synthesis process) 205 serving as an image memory used for synthesis process, an image memory (for movement amount detection) 206 serving as an image memory used to detect the movement amount between images continuously photographed, and a movement amount calculation unit 207 calculating the movement amount between the images.

The movement amount calculation unit 207 acquires both an image signal supplied from the image signal processing unit 203 and an image of the previous frame stored in the image memory (for movement amount detection) 206. The movement amount calculation unit 207 then detects the movement amounts of the present image and the image of the previous frame. For example, the movement amount calculation unit 207 performs a matching process of matching the pixels of two images continuously photographed, that is, the matching process of determining the photographed regions of the same subject to calculate the number of pixels moved between the images.

The movement amount calculation unit 207 calculates a motion vector (GMV: Global Motion Vector) corresponding to movement of an entire image and a block unit as a division region of an image, or a block correspondence motion vector indicating the movement amount of a pixel unit.

The block can be set according to various methods. The movement amount is calculated for one pixel unit or a block of an n×m pixel unit. In the following description, it is assumed that the concept of one pixel or a block is included. That is, a block correspondence vector refers to a vector corresponding to a division region divided from one image frame and formed by a plurality of pixels, or a vector corresponding to the pixels of one pixel unit.

The movement amount calculation unit 207 records the motion vector (GMV: Global Motion Vector) corresponding to the movement of the entire image and a block correspondence motion vector indicating the division region of an image or the movement amount of the pixel unit in the movement amount memory 208. The motion vector (GMV: Global Motion Vector) corresponding to the movement of the entire image refers to a motion vector corresponding to the movement of the entire image occurring with the movement of a camera.

The movement amount calculation unit 207 generates vector information having the number of movement pixels and a movement direction and a map calculated by an image unit or the block unit, that is, a motion vector map, as movement amount information. The movement amount calculation unit 207 compares the image n to the preceding image n−1, for example, when the movement amount calculation unit 207 calculates the movement amount of the image n. The movement amount calculation unit 207 stores the detected movement amount as a movement amount corresponding to the image n in the movement amount memory 208. An example of the vector information (motion vector map) serving as the movement amount detected by the movement amount calculation unit 207 will be described in detail below.

The image memory (for the synthesis process) 205 is a memory which stores the images to perform the synthesis process on the images photographed continuously, that is, to generate the panorama images. The image memory (for the synthesis process) 205 may store all of a plurality of images photographed in the panorama photographing mode. For example, the image memory 205 may select and store only the middle regions of the images in which the strip regions necessary to generate the panorama images are guaranteed by cutting the ends of the images. With such a configuration, the necessary memory capacity can be reduced.

After the photographing process ends, the image synthesis unit 210 performs the image synthesis process of extracting the image from the image memory (for the synthesis process) 205, and cutting the image into the strip regions, and connecting the strip regions to generate the left-eye synthesized image (left-eye panorama image) and the right-eye synthesized image (right-eye panorama image).

After the photographing process ends, the image synthesis unit 210 inputs the plurality of images (or partial images) stored during the photographing process in the image memory (for the synthesis process) 205. In addition, the image synthesis unit 210 also inputs various parameters such as the movement amounts corresponding to the images stored in the movement amount memory 208 and offset information used to determine the setting positions of the left-eye image strip and the right-eye image strip from the memory 209.

The image synthesis unit 210 sets the left-eye image strip and the right-eye image strip in the images continuously photographed using the input information and generates the left-eye synthesized image (for example, the left-eye panorama image) and the right-eye synthesized image (for example, the right-eye panorama image) by performing the process of cutting and connecting the image strips. The image synthesis unit 210 records strip region information of each photographed image included in the synthesized image generated by image synthesis unit 210 in the memory 209.

An image evaluation unit 211 evaluates whether the left-eye synthesized image and the right-eye synthesized image generated by the image synthesis unit 210 are proper for display of a 3-dimensional image. The image evaluation unit 211 acquires the strip region information from the memory 209 and acquires the movement amount information (motion vector information) generated by the movement amount detection unit 207 from the movement amount memory 208 to evaluate whether the images generated by the image synthesis unit 210 are proper for displaying the 3-dimensional images.

For example, the image evaluation unit 211 analyzes the movement amount of a moving subject included in each of the left-eye synthesized image and the right-eye synthesized image generated by the image synthesis unit 210. In addition, the image evaluation unit 211 analyzes a range or the like of the parallax of the subject included in each of the left-eye synthesized image and the right-eye synthesized image generated by the image synthesis unit 210 to determine whether the images generated by the image synthesis unit 210 are proper as the 3-dimensional images.

When a moving subject is included in the left-eye image and the right-eye image, as described above with reference to FIGS. 8A and 8B, the parallax of the moving subject is not appropriately set and thus the 3-dimensional image may not be appropriately displayed.

When the range of the parallax of the subject included in the left-eye image and the right-eye image is too large, that is, when “another subject with a large parallax” is included in a part of the image, as described above with reference to FIG. 9, a discontinuous portion may occur in the connected part of at least one of the near distant landscape and the far distant landscape in the image.

The image evaluation unit 211 analyzes the moving subject or the range of the parallax of the left-eye synthesized image and the right-eye synthesized image generated by the image synthesis unit 210 by applying the movement amount information (motion vector information) generated by the movement amount detection unit 207. The image evaluation unit 211 acquires image preset evaluation determination information (for example, a threshold value) from the memory 209 and compares image analysis information to the evaluation determination information (threshold value) to determine whether the left-eye synthesized image and the right-eye synthesized image generated by the image synthesis unit 210 are proper for displaying the 3-dimensional images.

For example, when the determination result is Yes, that is, it is determined that the left-eye synthesized image and the right-eye synthesized image generated by the image synthesis unit 210 are proper for displaying the 3-dimensional images, the images are recorded in a recording unit 212.

On the other hand, when the determination result is No, that is, it is determined that the left-eye synthesized image and the right-eye synthesized image generated by the image synthesis unit 210 are not proper for displaying the 3-dimensional images, display of a warning message, output of a warning sound, or the like is performed in an output unit 204.

When a user makes a request to record this warning, this warning is recorded in the recording unit 212. When a user gives no request to record the warning message, sound, or the like, the recording process stops. For example, the user can then retry the photographing process.

The details of the evaluation process will be described in detail below.

When the image recording process is performed in the recording unit (recording medium) 212, for example, a compression process such as JPEG is performed on the respective images and then the images are recorded.

The evaluation result generated by the image evaluation unit 211 may be recorded as attribute information (metadata) corresponding to the image in the medium. In this case, detailed information such as the presence or absence of a moving subject, the position of the moving subject or information regarding an occupation ratio or the like of the moving subject to the image, and information regarding the range of the parallax included in the image are recorded. Ranking information indicating an evaluation value determined based on the detailed information, for example, an evaluation value determined in high evaluation order (S, A, B, C, and D), may be set.

By recording the evaluation information as the attribute information (metadata) corresponding to the images, it is possible to perform, for example, a process of reading the metadata on a display apparatus such as a PC displaying 3D images, obtaining information or the like regarding the positions of the moving subject included in the images, and resolving the unnaturalness of the 3D images by an image correction process or the like on the moving subject.

In this way, the recording unit (recording medium) 212 records the synthesized images synthesized by the image synthesis unit 210, that is, the left-eye synthesized image (the left-eye panorama image) and the right-eye synthesized image (the right-eye panorama image), and records the image evaluation information generated by the image evaluation unit 211 as the attribute information (metadata) of the images.

The recording unit (recording medium) 212 may be realized by any recording medium, as long as the recording medium, such as a hard disk, a magneto-optical disk, a DVD (Digital Versatile Disc), an MD (Mini Disk), a semiconductor memory, and a magnetic tape, is capable of recording a digital signal.

Although not illustrated in FIG. 10, the imaging apparatus 200 includes a shutter operated by a user, an input operation unit performing various kinds of inputting such as a mode setting process, a control unit controlling the processes performed in the imaging apparatus 200, a program processing each constituent unit other than the control unit, and a recording unit (memory) recording the parameters as well as the configuration shown in FIG. 10.

The processing of the constituent units of the imaging apparatus 200 shown in FIG. 10 and processes of inputting and outputting data are performed under the control of the control unit of the imaging apparatus 200. The control unit reads the programs stored in advance in the memory of the imaging apparatus 200 and performs all of the controls, such as a process of acquiring the photographed images, a process of processing data, a process of generating the synthesized images, a process of recording the generated synthesized images, and a display process, performed in the imaging apparatus 200 in accordance with the program.

### 4. Orders of Image Photographing Process and Image Processing Process

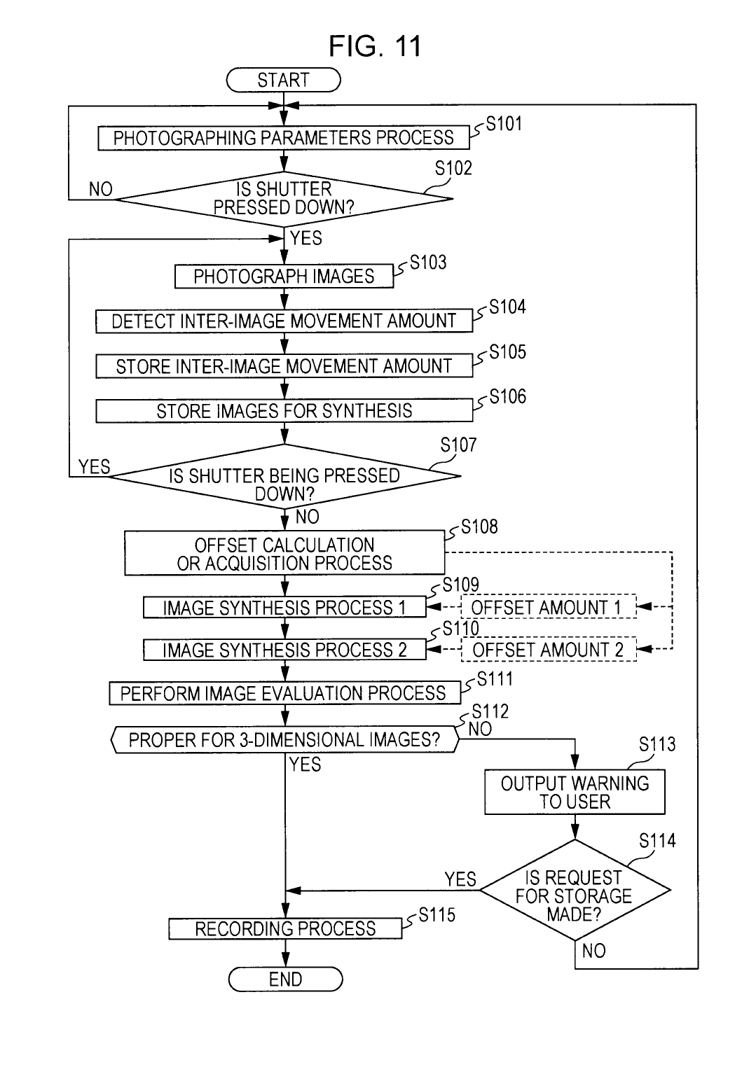

Next, an exemplary processing order performed in the image processing apparatus according to the embodiment of the invention will be described with reference to the flowchart shown in FIG. 11.

The processing according to the flowchart shown in FIG. 11 is performed under the control of the control unit of the image capturing apparatus 200, for example, shown in FIG. 10.

The process of each step in the flowchart shown in FIG. 11 will be described.

First, hardware diagnosis or initialization is performed by turning on the image processing apparatus (for example, the imaging apparatus 200), and then the process proceeds to step S101.

In step S101, various photographing parameters are calculated. In step S101, for example, information regarding lightness identified by an exposure meter is acquired and the photographing parameters such as an aperture value or a shutter speed are calculated.

Subsequently, the process proceeds to step S102 and the control unit determines whether a user operates the shutter. Here, it is assumed that a 3D panorama photographing mode is set in advance.

In the 3D panorama photographing mode, the user operates the shutter to photograph a plurality of images continuously, and a process is performed such that the left-eye image strip and the right-eye image strip are cut out from the photographed images and the left-eye synthesized image (panorama image) and the right-eye synthesized image (panorama image) applied to display a 3D image are generated and recorded.

In step S102, when the control unit does not detect that the user operates the shutter, the process returns to step S101.

In step S102, on the other hand, when the control unit detects the user operates the shutter, the process proceeds to step S103.

In step S103, based on the parameters calculated in step S101, the control unit performs control to start the photographing process. Specifically, for example, the control unit adjusts a diaphragm driving unit of the lens system 201 shown in FIG. 10 to start photographing the images.

The image photographing process is performed as a process of continuously photographing the plurality of images. The electric signals respectively corresponding to the continuously photographed images are sequentially read from the imaging element 202 shown in FIG. 10 to perform the processes such as gamma correction or contour enhancement correction in the image signal processing unit 203. Then, the processed results are displayed on the display unit 204 and are sequentially supplied to the memories 205 and 206 and the movement amount detection unit 207.

Next, the process proceeds to step S104 to calculate the movement amount between the images. This process is performed by the movement amount detection unit 207 shown in FIG. 10.

The movement amount detection unit 207 acquires both the image signal supplied from the image signal processing unit 203 and the image of the previous frame stored in the image memory (for movement amount detection) 206, and detects the movement amounts of the current image and the image of the previous frame.

The calculated movement amounts correspond to the number of pixels between the images calculated, for example, as described above, by performing the matching process for the pixels of two images continuously photographed, that is, the matching process of determining the photographed regions of the same subject. As described above, the movement amount detection unit 207 calculates the motion vector (GMV: Global Motion Vector) corresponding to the movement of the entire image and the motion vector corresponding to the division region of an image or the block indicating the movement amount of the pixel unit, and records the calculated movement amount information in the movement amount memory 208. The motion vector (GMV: Global Motion Vector) corresponding to the movement of the entire image is a motion vector corresponding to the movement of the entire image occurring with the movement of a camera.

For example, the movement amount is calculated as the number of movement pixels. The movement amount of the image n is calculated by comparing the image n to the preceding image n−1, and the detected movement amount (number of pixels) is stored as the movement amount corresponding to the image n in the movement amount memory 208.

The movement amount storage process corresponds to the storage process of step S105. In step S105, the movement amount of each image detected in step S104 is stored in the movement amount memory 208 shown in FIG. 10 in association with the ID of each image.

Subsequently, the process proceeds to step S106. Then, the image photographed in step S103 and processed by the image signal processing unit 203 is stored in the image memory (for the image synthesis process) 205 shown in FIG. 10. As described above, the image memory (for the synthesis process) 205 stores all of the images such as the n+1 images photographed in the panorama photographing mode (or the 3D panorama photographing mode), but may select and store, for example, only the middle regions of the images in which the strip regions necessary to generate the panorama images (the 3D panorama images) are guaranteed by cutting the ends of the images. With such a configuration, the necessary memory capacity can be reduced. Moreover, the image memory (for the synthesis process) 205 may store the images after performing the compression process such as JPEG.

Subsequently, the process proceeds to step S107 and the control unit determines whether the user continues pressing down the shutter. That is, the control unit determines photographing end time.

When it is determined that the user continues pressing down the shutter, the process returns to step S103 to continue the photographing process, and photographing the image of the subject is repeated.

On the other hand, when the user stops pressing down the shutter in step S107, the process proceeds to step S108 to perform the photographing end process.

When the continuous image photographing process ends in the panorama photographing mode, the process proceeds to step S108.

In step S108, the image synthesis unit 210 acquires an offset condition of the strip regions satisfying a generation condition of the left-eye image and the right-eye image formed as the 3D image, that is, the allowable offset amount from the memory 209. Alternatively, the image synthesis unit 210 acquires the parameters necessary for calculating the allowable offset amounts from the memory 209 and calculates the allowable offset amounts.

Subsequently, the process proceeds to step S109 to perform a first image synthesis process using the photographed images. The process proceeds to step S110 to perform a second image synthesis process using the photographed images.

The image synthesis processes of steps S109 and S110 are processes of generating the left-eye synthesized image and the right-eye synthesized image applied to display the 3D images. For example, the synthesized images are generated as the panorama images.

The left-eye synthesis image is generated by the synthesis process of extracting and connecting only the left-eye image strips, as described above. Likewise, the right-eye synthesis image is generated by the synthesis process of extracting and connecting only the right-eye image strips. As the result of the image synthesis process, two panorama images shown in Parts (2a) and (2b) of FIG. 7 are generated.

The image synthesis processes of steps S109 and S110 are performed using the plurality of images (or partial images) recorded in the image memory (for the synthesis process) 205 in the continuous image photographing process until it is determined that the user presses down the shutter in step S102 and then it is confirmed that the user stops pressing down the shutter in step S107.

When the synthesis processes are performed, the image synthesis unit 210 acquires the movement amounts associated with the plurality of images from the movement amount memory 208 and acquires the allowable offset amounts from the memory 209. Alternatively, the image synthesis unit 210 acquires the parameters necessary for calculating the allowable offset amounts from the memory 209 and calculates the allowable offset amounts.

The image synthesis unit 210 determines the strip regions as the cutout regions of the images based on the movement amounts and the allowable offset amounts.

That is, the strip region of the left-eye image strip used to form the left-eye synthesized image and the strip region of the right-eye image strip used to form the right-eye synthesized image are determined.

The left-eye image strip used to form the left-eye synthesized image is set at the position offset right by a predetermined amount from the middle of the image.

The right-eye image strip used to form the right-eye synthesized image is set at the position offset left by a predetermined amount from the middle of the image.

In the setting process of the strip regions, the image synthesis unit 210 determines the strip regions so as to satisfy the offset condition satisfying the generation condition of the left-eye image and the right-eye image. That is, the image synthesis unit 210 sets the offsets of the strips so as to satisfy the allowable offset amounts acquired from the memory or calculated based on the parameters acquired from the memory in step S108, and performs the image cutting.

The image synthesis unit 210 performs the image synthesis process by cutting and connecting the left-eye image strip and the right-eye image strip in each image to generate the left-eye synthesized image and the right-eye synthesized image.

When the images (or partial images) recorded in the image memory (for the synthesis process) 205 are data compressed by JPEG or the like, an adaptive decompression process of setting the image regions, where the images compressed by JPEG or the like are decompressed, only in the strip regions used as the synthesized images may be performed based on the movement amounts between the images calculated in step S104.

In the processes of steps S109 and S110, the left-eye synthesized image and the right-eye synthesized image applied to display the 3D images are generated.

Subsequently, the process proceeds to step S111 and the image evaluation process is performed on the left-eye synthesized image and the right-eye synthesized image synthesized in step S109 and step S110.

The image evaluation process is the process of the image evaluation unit 211 shown in FIG. 10. The image evaluation unit 211 evaluates whether the left-eye synthesized image and the right-eye synthesized image generated by the image synthesis unit 210 are proper for displaying the 3-dimensional images.

Specifically, the image evaluation unit 211 analyzes the movement amount of the moving subject included in each of the left-eye synthesized image and the right-eye synthesized image generated by the image synthesis unit 210 or the range of the parallax of the subject included in each image.

When the moving subject is included in the left-eye image and the right-eye image, as described above with reference to FIGS. 8A and 8B, the parallax of the moving subject may not be appropriately set and the 3-dimensional image may be not appropriately displayed.

When the range of the parallax of the subject included in the left-eye image and the right-eye image is too large, as described above with reference to FIG. 9, a discontinuous portion may occur in the connected part of at least one of the near distant landscape and the far distant landscape in the image.

The image evaluation unit 211 determines whether the left-eye synthesized image and the right-eye synthesized image generated by the image synthesis unit 210 are images proper for displaying the 3-dimensional images, by analyzing the moving subject or the range of the parallax in the left-eye synthesized image and the right-eye synthesized image generated by the image synthesis unit 210, acquiring the preset image evaluation determination information (for example, a threshold value) or the like from the memory 209, and comparing the image analysis information to the determination information (the threshold value).

Specifically, the image evaluation unit 211 performs a process of evaluating the properness of the synthesized images as the 3-dimensional images through analysis of a block correspondence difference vector calculated by subtracting a global motion vector indicating the movement of the entire image from a block motion vector which is a motion vector of a block unit of the synthesized images generated by the image synthesis unit 210.

Then, the image evaluation unit 211 compares a predetermined threshold value to at least one of (1) a block area (S) of a block having the block correspondence difference vector with a size equal to or larger than the predetermined threshold value and (2) a movement amount additional value (L) which is an additional value of a movement amount corresponding to the vector length of the block correspondence difference vector with the size equal to or larger than the predetermined threshold value.

Then, the image evaluation unit 211 performs a process of determining that the synthesized images are not proper as the 3-dimensional images, when the block area (S) is equal to or greater than a predetermined area threshold value or when the movement amount addition value (L) is equal to or greater than a predetermined movement amount threshold value. This process will be described in detail below.

When the determination result is Yes in step S112, that is, when the left-eye synthesized image and the right-eye synthesized image generated by the image synthesis unit 210 are images proper for displaying the 3-dimensional images based on the comparison between an image evaluation value and a threshold value (image evaluation determination information) (the determination result is Yes in step S112), the process proceeds to step S115 and the images are recorded in the recording unit 212.

On the other hand, when the determination result is No in step S112, that is, when the left-eye synthesized image and the right-eye synthesized image generated by the image synthesis unit 210 are images proper for displaying the 3-dimensional images based on the comparison between the image evaluation value and the threshold value (image evaluation determination information) (the determination result of step S112 is No), the process proceeds to step S113.

In step S113, the display of a warning message, the output of a warning sound, or the like is performed in an output unit 204 shown in FIG. 10.

When a user makes a request to record this warning in step S114, (the determination result of step S114 is Yes), the process proceeds to step S115 and the left-eye synthesized image and the right-eye synthesized image generated by the image synthesis unit 210 are recorded in the recording unit 212.

When the user makes no request to record this warning in step S114, (the determination result of step S114 is No), the recording process stops, the process returns to step S101, and then a process of transitioning a mode in which images can be currently photographed is performed. For example, the user can subsequently retry the photographing process.

The determination process of step S113 and step S114 and the control of the recording process of step S115 are performed, for example, by the control unit of the image processing apparatus. The control unit outputs the warning to the output unit 204, when the image evaluation unit 211 determines that the synthesized images are not proper as the 3-dimensional images. The control unit suspends the recording process of the synthesized images by the recording unit (recording medium) 212 and performs control so as to perform the recording process under the condition that the user inputs a recording request in response to the output of the warning.

When the data is recorded in the recording unit (recording medium) 212 in step S115, as described above, the images are recorded, for example, after the compression process such as JPEG is performed on the images.

The image evaluation result generated by the image evaluation unit 211 is also recorded as the attribute information (metadata) corresponding to the images. For example, the detailed information such as the presence or absence of a moving subject, the position of the moving subject or the information regarding an occupation ratio or the like of the moving subject to the image, and the information regarding the range of the parallax included in the image are recorded. The ranking information indicating an evaluation value determined based on the detailed information, for example, an evaluation value determined in high evaluation order (S, A, B, C, and D), may be set.

By recording the evaluation information as the attribute information (metadata) corresponding to the images, it is possible to perform, for example, the process of reading the metadata on a display apparatus such as a PC displaying 3D images, obtaining the information or the like regarding the positions of the moving subject included in the images, and resolving the unnaturalness of the 3D images by an image correction process or the like on the moving subject.

### 5. Principle of Properness Determination Process for 3-Dimensional Image Based on Motion Vector

Next, a principle of the proper evaluation process on the 3-dimensional images based on the motion vector will be described.

The movement amount detection unit 207 generates a motion vector map as movement amount information and records the motion vector map in the movement amount memory 208. The image evaluation unit 211 applies the motion vector map and evaluates the images.

As described above, the movement amount detection unit 207 of the image processing apparatus (imaging apparatus 200) shown in FIG. 10 acquires both the image signal supplied from the image signal processing unit 203 and the image of the previous frame stored in the image memory (for movement amount detection) 206, and detects the movement amounts of the current image and the image of the previous frame. The movement amount detection unit 207 performs the matching process of matching the pixels of two images continuously photographed, that is, the matching process of determining the photographed regions of the same subject, and detects the number of movement pixels of the image unit and the block unit and the motion vector from the movement direction in regard of the respective images.

Thus, the movement amount detection unit 207 calculates the motion vector (GMV: Global Motion Vector) corresponding to the movement of the entire image and the motion vector corresponding to the division region of an image or the block indicating the movement amount of the pixel unit, and records the calculated movement amount information in the movement amount memory 208.

For example, the movement amount detection unit 207 generates the motion vector map as the movement amount information. That is, the movement amount detection unit 207 generates the motion vector (GMV: Global Motion Vector) corresponding to the motion of the entire image and the motion vector map in which the motion vector corresponding to the block indicating the movement amount of the block unit (including the pixel unit) as the division region of an image is mapped.

The motion vector map includes information regarding (a) correspondence data between an image ID, which is identification information of an image, and the motion vector (GMV: Global Motion Vector) corresponding to the motion of the entire image and (b) correspondence data between block position information (for example, coordinate information) indicating the block position in an image and the motion vector corresponding to each block.

The movement amount detection unit 207 generates the motion vector map including the above information as the movement amount information corresponding to each image, and stores the motion vector map in the movement amount memory 208.

The image evaluation unit 211 acquires the motion vector map from the movement amount memory 208 and evaluates the images, that is, evaluates the properness of the images as the 3-dimensional images.

The image evaluation unit 211 performs the evaluation process on each of the left-eye synthesized image and the right-eye synthesized image generated by the image synthesis unit 210.

The image evaluation unit 211 evaluates the properness of each of the left-eye synthesized image and the right-eye synthesized image generated by the image synthesis unit 210 as the 3-dimensional images.

When the image evaluation unit 211 performs the properness evaluation, the image evaluation unit 211 analyzes the block correspondence difference vector calculated by subtracting the global motion vector indicating the movement of the entire image from the block motion vector which is a motion vector of the block unit of the synthesized images.

Specifically, the image evaluation unit 211 compares a predetermined threshold value to one of (1) the block area (S) of a block having the block correspondence difference vector with a size equal to or larger than the predetermined threshold value and (2) the movement amount additional value (L) which is an additional value of a movement amount corresponding to the vector length of the block correspondence difference vector with the size equal to or larger than the predetermined threshold value. Then, the image evaluation unit 211 performs the process of determining that the synthesized images are not proper as the 3-dimensional images, when the block area (S) is equal to or greater than the predetermined area threshold value or when the movement amount addition value (L) is equal to or greater than the predetermined movement amount threshold value.

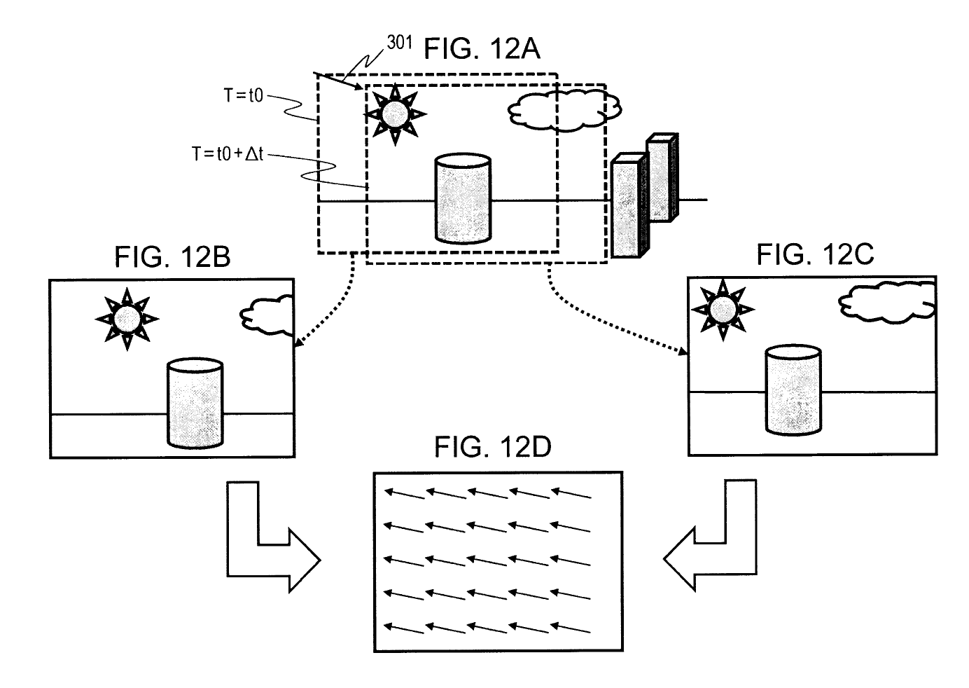

The principle of the properness determination process will be described with reference to FIGS. 12A to 14C.

(1) A case in which the motion vector is nearly uniform in an image and (2) a case in which the motion vector is not uniform in an image will be sequentially described.

In (1) the case in which the motion vector is nearly uniform in an image, the image is proper as a 3-dimensional image. On the other hand, in (2) the case in which the motion vector is not uniform in an image, the image is sometimes not proper as a 3-dimensional image.

The principle of establishment of the properness determination process will be described with reference to FIGS. 12A to 14C.

(1) Case in which Motion Vectors are Nearly Uniform in Image

An exemplary structure of the motion vector map in a case in which the motion vectors are uniform in an image and the properness of the image as a 3-dimensional image will be described with reference to FIGS. 12A to 12D.

FIGS. 12A to 12D are diagrams illustrating an image photographing process, a photographed image at time T=t0, a photographed image at time T=t0+Δt, and structure information of the motion vector map, respectively.

In the image photographing process in FIG. 12A, an example where an image is photographed while moving a camera is shown.

That is, the initial image is first photographed at time T=t0, and then the subsequent image is photographed at time T=t0+Δt when the camera is moved along an arrow 301.

Two images in FIGS. 12B and 12C are acquired by continuously photographing the images while the camera is moved. That is, two images of the photographed image at time T=t0 in FIG. 12B and the photographed image at time T=t0+Δt in FIG. 12C, are acquired.

The movement amount detection unit 207 detects the movement amount using, for example, the two images. A motion vector between the two images is calculated from the two images as the movement amount detection process. There are various methods of calculating the motion vector. Here, a method of dividing the image into image regions and calculating the motion vector for each block will be described. The global motion vector (GMV) corresponding to the movement of the entire image can be calculated, for example, from an average of the block correspondence motion vectors.

The movement amount detection unit 207 calculates the motion vectors to calculate how much a subject is moved in the second image with reference to the first image. By this process, a vector group shown in FIG. 12D can be obtained. Arrows shown in FIG. 12D indicate the block correspondence motion vectors.

In this example, since there is no moving subject in the image, all of the motion vectors have the same direction and size. These motion vectors are obtained by the movement of the camera and are the uniform vectors which are the same as the global motion vector (GMV) which is a vector which corresponds to the entire image.

The image synthesis unit 210 can generate the left-eye synthesized image and the right-eye synthesized image by positioning and connecting the two images through application of the vectors.

In the setting shown in FIG. 12A to 12D, that is, in the case in which all of the motion vectors are almost the same as the GMV, the problem with the parallax caused due to a moving subject in the synthesized images does not occur. That is, the subject in which an erroneous parallax caused due to the moving subject does not occur.

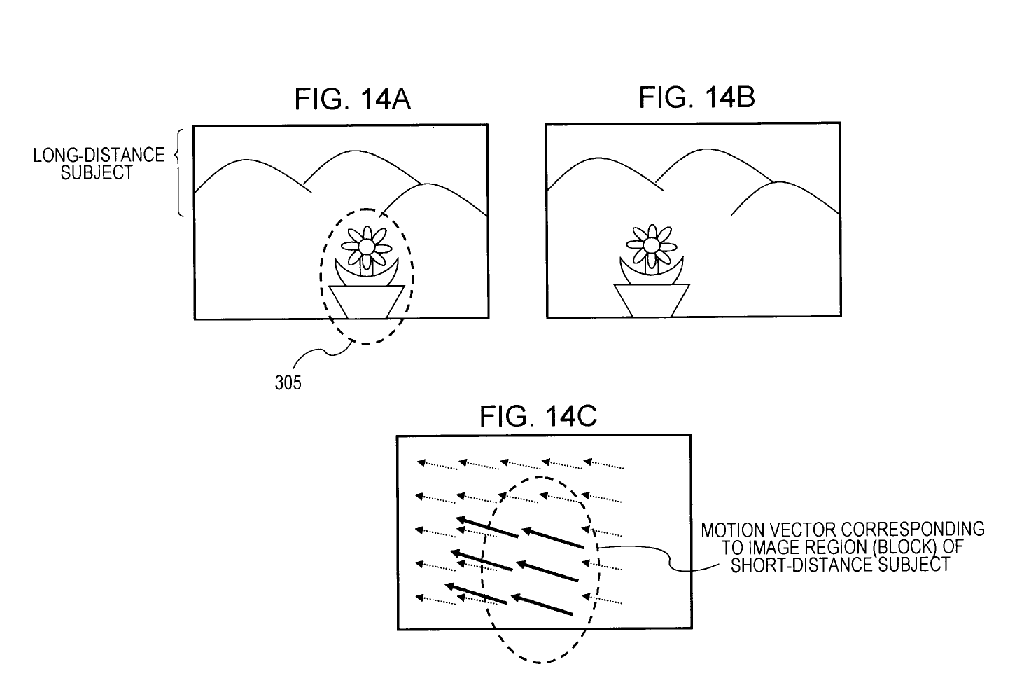

When the vector map formed from the uniform vector group shown in FIG. 12D is obtained, the image evaluation unit 211 can determine that there is no moving subject in the image. Moreover, the image evaluation unit 211 can determine that a very close subject and a very distant subject coexist, that is, “another subject with a large parallax” is not included in a part of the image. The reason will be described below with reference to FIGS. 14A to 14C.

When it is determined that the synthesized images are proper as the 3-dimensional images, the images are recorded in the medium without performing the process of outputting the warning to the user.

The image evaluation unit 211 also performs a process of acquiring the motion vector map (for example, the motion vector map shown in FIG. 12D) generated by the movement amount detection unit 207 and corresponding to each photographed image or the generation information from the movement amount memory 208, generating a “moving subject visualized image” corresponding to the synthesized image (the left-eye synthesized image or the right-eye synthesized image) and described below (6. Details of Image Evaluation Process in Image Evaluation Unit), and evaluating the properness of each synthesized image as the 3-dimensional image.

This process will be described in detail below (6. Details of Image Evaluation Process in Image Evaluation Unit).

(2) Case in which Motion Vectors are not Uniform in Image

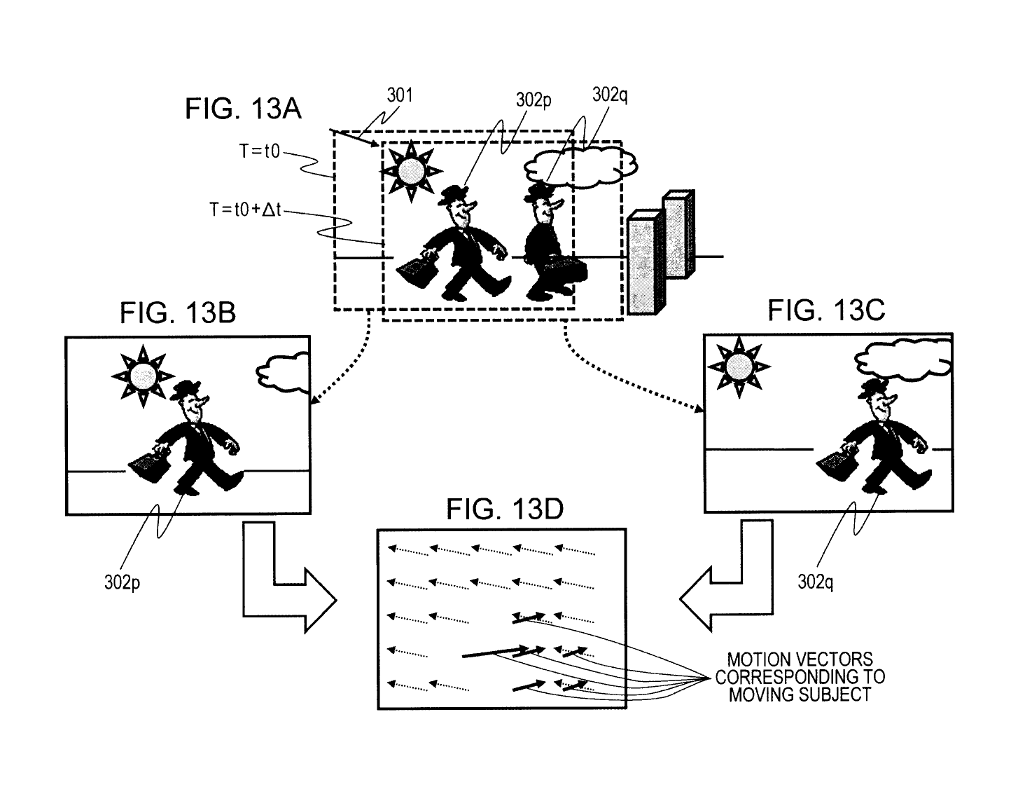

Next, an exemplary structure of the motion vector map in a case in which the motion vectors are not uniform in an image and the properness of the image as a 3-dimensional image will be described with reference to FIGS. 13A to 13D.

Like FIGS. 12A to 12D, FIGS. 13A to 13D are diagrams illustrating an image photographing process, a photographed image at time T=t0, a photographed image at time T=t0+Δt, and structure information of the motion vector map, respectively.

In the image photographing process in FIG. 13A, an example where an image is photographed while moving a camera is shown.

That is, the initial image is first photographed at time T=t0, and then the subsequent image is photographed at time T=t0+Δt when the camera is moved along an arrow 301.

In this example, a pedestrian 302 which is a moving subject is included in the image. A pedestrian 302p is a pedestrian included in the photographed image at time T=t0. A pedestrian 302q is a pedestrian included in the photographed image at time T=t0+Δt. These pedestrians are the same pedestrian and a moving subject who is moving for time Δt.

Two images in FIGS. 13B and 13C are acquired by continuously photographing the images while the camera is moved. That is, two images of the photographed image at time T=t0 in FIG. 13B and the photographed image at time T=t0+Δt in FIG. 13C, are acquired.

The movement amount detection unit 207 detects the movement amount using, for example, the two images. A motion vector between the two images is calculated from the two images as the movement amount detection process.

By this process, a vector group shown in FIG. 13D can be obtained. Arrows shown in FIG. 13D indicate the block correspondence motion vectors.

The block correspondence vector group shown in FIG. 13D is different from the above-described block correspondence vector shown in FIG. 12D and thus is not uniform.

That is, the motion vectors in parts of the images where the pedestrian 302 as the moving subject is photographed are vectors on which both the movement of the camera and the movement of the moving subject are reflected.

The vectors of the vector group indicated by dot lines in FIG. 13D are block correspondence motion vectors having no moving subject and are motion vectors caused due to only the movement of the camera. However, the motion vectors indicated by solid lines are vectors on which both the movement of the camera and the movement of the moving subject are reflected.

When the moving subject is included in the image, the block correspondence motion vectors are not uniform.

In the example shown in FIG. 13A to 13D, the example where the non-uniformity of the motion vectors occurs in the case in which the moving subject is included in the photographed images has been described. For example, the non-uniformity of the motion vectors between two images occurs also when a very close subject and a very distant subject are simultaneously photographed, that is, “another subject with a large parallax” is included in parts of the images, as described in the exemplary images described with reference to FIG. 9.

This is because the movement amount by the parallax of the close subject is large (different) than the parallax of the distant subject.

This example will be described with reference to FIGS. 14A to 14C.

FIGS. 14A to 14C are diagrams illustrating a photographed image at time T=t0, a photographed image at time T=t0+Δt, and structure information of the motion vector map, respectively.

The photographed image at time T=t0 (in FIG. 14A) and the photographed image at time T=t0+Δt (in FIG. 14B) are images continuously photographed while the camera is moved.

A short-distance subject (flower) 305 extremely close to the camera and a long-distance subject are included in the image.

The camera is set to be close to the short-distance subject (flower) 305 and photographs the short-distance subject. Therefore, when the camera is moved, the position of the short-distance subject (flower) 305 is considerably deviated. As a consequence, the image position of the short-distance subject (flower) 305 in the photographed image at time T=t0 (in FIG. 14A) is considerably different from that in the photographed image at time T=t0+Δt (in FIG. 14B.

Two images in FIGS. 14A and 14B are acquired by continuously photographing the images while the camera is moved. That is, two images of the photographed image at time T=t0 in FIG. 14A and the photographed image at time T=t0+Δt in FIG. 14B, are acquired.

The movement amount detection unit 207 detects the movement amount using, for example, the two images. A motion vector between the two images is calculated from the two images as the movement amount detection process.

By this process, a vector group shown in FIG. 14C can be obtained. Arrows shown in FIG. 14C indicate the motion vectors corresponding to the blocks.

The block correspondence vector group shown in FIG. 14C is different from the block correspondence vector shown in FIG. 12D and thus is not uniform.

A moving subject is included in the photographed images and both the subjects are a motionless subject. However, the block correspondence motion vector of the image part where the short-distance subject (flower) 305 is photographed is considerably larger than the motion vector of the image part where the other long-distance subjects are photographed.

This is because the movement amount of the short-distance subject in the image is large due to the movement of the camera.

When a very close subject and a distant subject are simultaneously photographed in an image, the motion vectors are not uniform.

When the vector map formed from the non-uniform vector group is obtained as in FIG. 13D or 14C, the image evaluation unit 211 can determine that “there is the moving subject” in the images or that a very close subject and a distant subject are included in the images and thus “another subject with a large parallax is included” in the parts of the images.

Moreover, the image evaluation unit 211 generates the block correspondence difference vector based on the vector map formed from the non-uniform vector group, and performs final evaluation based on the generated block correspondence difference vector.

The image evaluation unit 211 acquires the motion vector map (for example, the motion vector map in FIG. 12D) corresponding to each of the photographed images generated by the movement amount detection unit 207 or the generation information from the movement amount memory 208, generates the “moving subject visualized image” corresponding to the synthesized image (the left-eye synthesized image or the right-eye synthesized image), and evaluates the properness of each synthesized image as the 3-dimensional image. This process will be described in detail below.

The image evaluation unit 211 outputs the warning to the user, when the image evaluation unit 211 determines that the synthesized image (the left-eye synthesized image or the right-eye synthesized image) generated by the image synthesis unit 210 is not proper as the 3-dimensional image.

### 6. Details of Image Evaluation Process in Image Evaluation Unit

As described above, the image evaluation unit 211 acquires, for example, the motion vector map and determines whether the images generated by the image synthesis unit 210 are proper for displaying the 3-dimensional images.

The image evaluation unit 211 can determine the properness based on the uniformity of the motion vectors, described above. Hereinafter, an exemplary algorithm used for the image evaluation unit 211 to determine the properness of the images as the 3-dimensional images based on the uniformity of the motion vectors will be described.

The image evaluation unit 211 performs the determination process based on the uniformity of the motion vectors. However, specifically, this determination process corresponds to a determination process whether the “moving subject” or the “other subject with a large parallax” having a great influence on the image quality of the 3D images is included in the images. The determination algorithm is applicable according to various methods.

Hereinafter, a method of determining that a subject of the region having a block correspondence vector different from the global motion vector (GMV) corresponding to the movement of the entire image include the “moving subject” or the “other subject with a large parallax” will be described as an example.

Since there are differences in the perception of the influence of the “moving subject” and the “other subject with a large parallax” on the image quality of the 3D images among individuals, it is difficult to measure the perception quantitatively.

However, it is possible to qualitatively determine whether the images are images proper for displaying the 3-dimensional images using the indexes:

(1) an area of the “moving subject” and the “other subject with a large parallax” occupying the image;

(2) a distance from the center of the screen of the “moving subject” or the “other subject with a large parallax”; and

(3) a movement amount of the “moving subject” or the “other subject with a large parallax” in the screen.

The image evaluation unit 211 calculates each of the above indexes using the images (the left-eye synthesized image and the right-eye synthesized image) generated by the image synthesis unit 210 and the motion vector information generated by the movement amount detection unit 207. Then, the image evaluation unit 211 determines whether the images generated by the image synthesis unit 210 are proper as the 3-dimensional images based on the calculated indexes. When the determination process is performed, information evaluation determination information (threshold value or the like) corresponding to each index stored in advance, for example, in the memory 209.

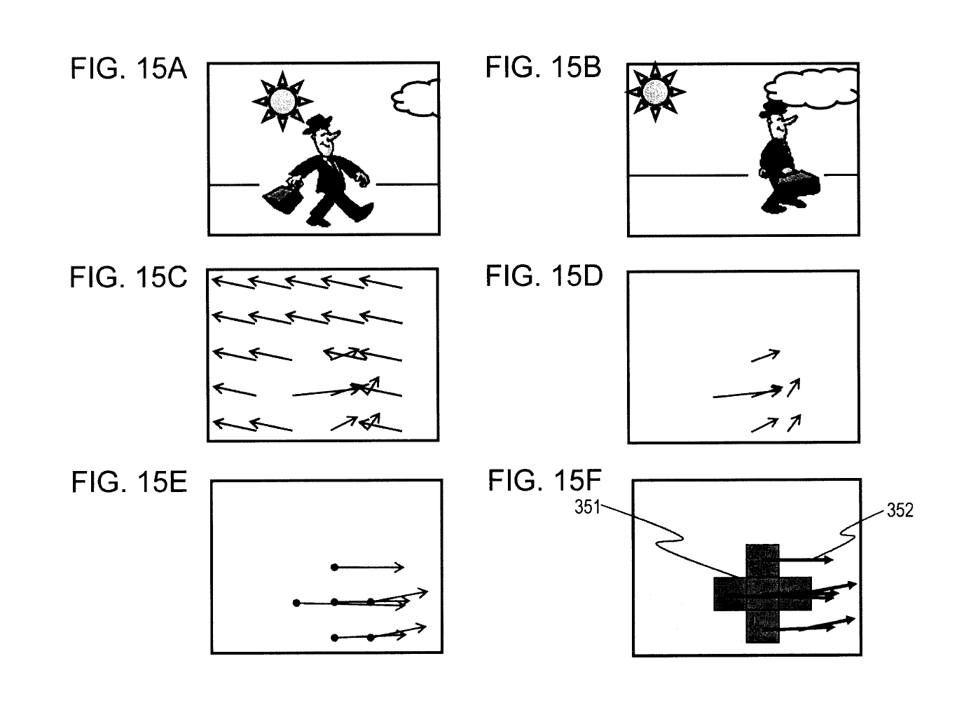

Exemplary processing performed on the images including the moving subject by the image evaluation unit 211 will be described with reference to FIGS. 15A to 15F. Hereinafter, the exemplary processing for the “moving subject” will be described. However, the same processing can be also performed on “another subject with a large parallax” instead of the “moving subject”.

FIGS. 15A to 15F are diagrams illustrating a photographed image at time T=t0, a photographed image at time T=t0+Δt, structure information of a motion vector map, motion vector information of only a moving subject, a difference vector (difference with GMV) of the part of the moving subject, and visualization information regarding moving subject regions and the vectors, respectively.

The motion vector map (FIG. 15C) is obtained from a plurality of images (FIGS. 15A and 15B) continuously photographed. This process is a process which the movement amount detection unit 207 performs according to the method described above with reference to FIGS. 12A and 12D and the like.

The block correspondence motion vectors in which only the block determined as a moving subject region is selected from the motion vector map shown in FIG. 15C form a vector map shown in FIG. 15D.

The block correspondence motion vector shown in FIG. 15D is a vector obtained by adding the global motion vector (GMV) caused by the movement of a camera and a motion vector caused by the movement of the moving subject.

Since the factor having an influence on the image quality of the 3-dimensional images is the movement of the moving subject on the background, the global motion vector (GMV) is subtracted from the motion vector of the moving subject. A block correspondence difference vector obtained as the subtraction result is referred to as a “real motion vector”.

In FIG. 15E, the block correspondence difference vector obtained by subtracting the global motion vector from the motion vectors of the motion subject is shown. The “real motion vector” serving as the block correspondence difference vector has an important role.

The block in which the block correspondence difference vector (“real motion vector”) in FIG. 15E is set is a block detected by the GMV and the other motion vectors. The block region can be determined as the detection region of the “moving subject”.

The image evaluation unit 211 evaluates the properness of the synthesized images as the 3-dimensional images through the analysis of the block correspondence difference vector calculated by subtracting the global motion vector indicating the movement of the entire image from the block motion vector which is the motion vector of the block unit of the synthesized images generated by the image synthesis unit 210.

FIG. 15F is the diagram illustrating only the block having the block correspondence difference vector with a size equal to or greater than the predetermined threshold value and the block correspondence difference vectors of this block among the block correspondence difference vectors of FIG. 15E.

In the block shown in FIG. 15F, a “moving subject detection region 351” distinguished from the other regions and a “real motion vector 352” (a block correspondence difference vector obtained by subtracting the global motion vector from the motion vector of the moving subject) of the “moving subject detection region 351” are shown. A “moving subject visualized image” can be generated by visualizing the moving subject information.

The image evaluation unit 211 can generate the “moving subject visualized image” and evaluate the images based on this information, that is, determine whether the synthesized image (the left-eye synthesized image or the right-eye synthesized image) generated by the image synthesis unit 210 are proper as the 3-dimensional image. This information enables the image to be displayed on, for example, the output unit 204 and enables a user to confirm the problem region such as the moving subject region which inhibits the properness of the image as the 3-dimensional image.

When the image evaluation unit 211 evaluates the properness of each of the left-eye synthesized image and the right-eye synthesized image generated by the image synthesis unit 210 as the 3-dimensional image, the image evaluation unit 211 analyzes the block correspondence difference vector (see FIGS. 15E and 15F) calculated by subtracting the global motion vector indicating the movement of the entire image from the block motion vector which is the motion vector of the block unit of the synthesized images. When this process is performed, the process is performed by applying, for example, the “moving subject visualized image”.

Specifically, the image evaluation unit 211 compares a predetermined threshold value to at least one of (1) the block area (S) of a block having the block correspondence difference vector with a size equal to or larger than the predetermined threshold value and (2) the movement amount additional value (L) which is an additional value of the movement amount corresponding to the vector length of the block correspondence difference vector with the size equal to or larger than the predetermined threshold value. Then, the image evaluation unit 211 performs the process of determining that the synthesized images are not proper as the 3-dimensional images, when the block area (S) is equal to or greater than the predetermined area threshold value or when the movement amount addition value (L) is equal to or greater than the predetermined movement amount threshold value.

As described above, the image synthesis unit 210 generates the left-eye image and the right-eye image for displaying the 3-dimensional images by connecting and joining the strip areas offset right and left from the center of the continuously photographed images.

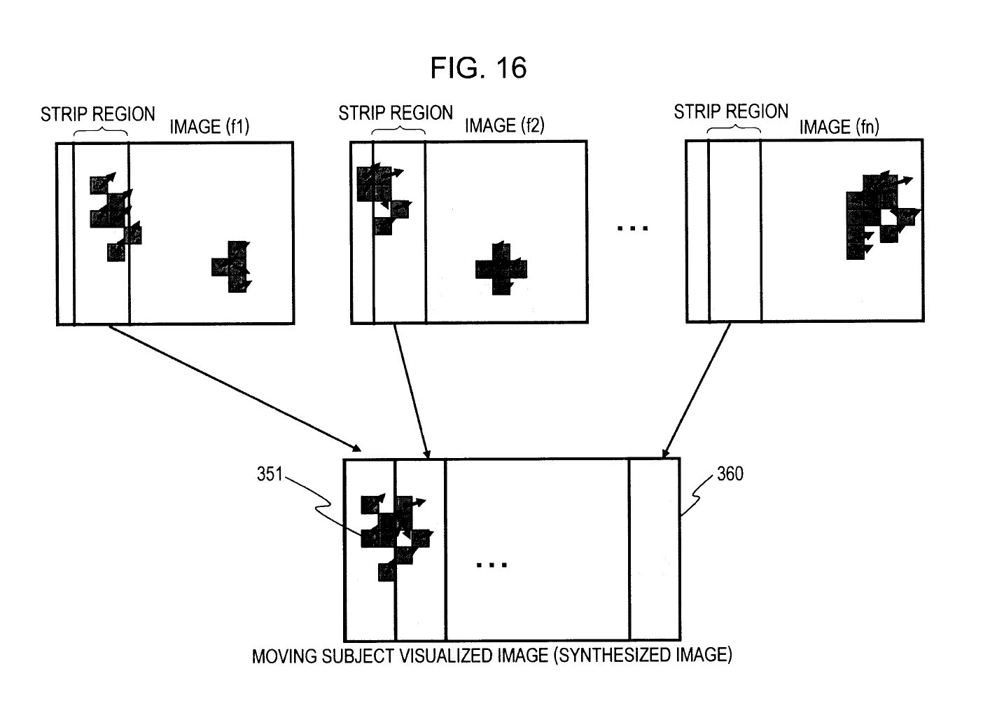

An exemplary process of generating the “moving subject visualized image” will be described with reference to FIG. 16.

As shown in FIG. 16, a “moving subject visualized image 360” can be generated by the strip connection process used in the process of generating the synthesized images, as in the process of generating the left-eye synthesized image and the right-eye synthesized image for displaying the 3-dimensional images.

Images (f1) to (fn) shown in the upper part of FIG. 16 are photographed images used in the process of generating the left-eye synthesized image and the right-eye synthesized image by the image synthesis unit 210.

The left-eye synthesized image and the right-eye synthesized image are generated by cutting and connecting the strip regions of the photographed images (f1) to (fn).

The “moving subject visualized image 360” is generated using the strip regions suitable for generating the left-eye synthesized image or the right-eye synthesized image generated by the image synthesis unit 210.

The photographed images (f1) to (fn) correspond to the image shown in FIG. 15F. That is, the photographed images (f1) to (fn) are the visualization information regarding the moving subject regions and the vectors (FIG. 15F). In other words, as described with reference to FIG. 15F, the photographed images (f1) to (fn) are images having the “real moving vector 352 (=the block correspondence difference vector obtained by subtracting the global motion vector from the motion vector of the moving subject) of the “moving subject detection region 351”.

The image evaluation unit 211 acquires the strip region information of the respective photographed images included in the synthesized images generated by the image synthesis unit 210 from the memory 209, generates the “visualization information regarding the moving subject regions and the vectors (in FIG. 15F)” in a strip region unit corresponding to the synthesized image generated by the image synthesis unit 210, and generates the “moving subject visualized image 360” shown in FIG. 16 by connecting the moving subject regions and the vectors.

The “moving subject visualized image 360” shown in FIG. 16 is a moving subject visualized image corresponding to the synthesized image (the left-eye synthesized image or the right-eye synthesized image) generated by the image synthesis unit 210.

The image evaluation unit 211 evaluates the images by applying the moving subject visualized image which is the visualization information. The moving subject visualized images shown in FIG. 16 are the images obtained using only moving subject detection information in the strip regions used to generate the 3D images. However, the invention is not limited to the strip region, but one moving subject visualized image may be generated by superimposition using the moving subject detection information of the entire image.

Hereinafter, a specific example of the image evaluation process by the moving subject visualized image 360 in the image evaluation unit 211 will be described.

As described above, the image evaluation unit 211 performs the process of evaluating the images generated by the image synthesis unit 210 by calculating the following indexes:

(1) an area of the “moving subject” or the “other subject with a large parallax”;

(2) a distance from the center of the screen of the “moving subject” or the “other subject with a large parallax”; and

(3) a movement amount of the “moving subject” or the “other subject with a large parallax” in the screen.

The image evaluation unit 211 evaluates whether the images are images proper for displaying the 3-dimensional images using these indexes.

Hereinafter, an exemplary process of calculating the index values by applying the moving subject visualized image 360 shown in FIG. 16 will be described.

(1) Exemplary Process of Calculating Ratio of “Moving Subject” or “Another Subject with Large Parallax” to Screen

The image evaluation unit 211 generates the moving subject visualized image 360 shown in FIG. 16 using the images generated by the image synthesis unit 210 and the motion vector information generated by the movement amount detection unit 207, and calculates the area of the “moving subject” or the “other subject with a large parallax” by applying the moving subject visualized image 360.

In the following description, the exemplary processing for the “moving subject” will be described, but the same processing is also applicable to the “other subject with a large parallax”.

When this processing is performed, a normalization process is performed based on the image size after the synthesis process. That is, an area ratio of the moving subject region to the entire image is calculated by the normalization process.

The image evaluation unit 211 calculates the area (S) of the moving subject region, that is, a “block area (S) of the block having the block correspondence difference vector with a size equal to greater than a predetermined threshold value” by the following expression.

$$S = \frac{1}{w \cdot h} {\sum }_{p} 1 \qquad ( Expression 1 )$$

A value (S) calculated by the above expression (Expression 1) is referred to as a moving subject area.

In the above expression, w denotes an image horizontal size after the synthesis, h denotes an image vertical size, and p denotes a pixel of the moving subject detection region.

That is, the above expression (Expression 1) corresponds to an expression used to calculate the area of the “moving subject detection region 351” in the moving subject visualized image 360 shown in FIG. 16.

The reason for performing the normalization to the image sizes after the synthesis is to eliminate the dependency on the image sizes under the influence of the area of the moving subject and the moving subject on deterioration in image quality. The deterioration in the image quality of the moving subject is less when the final image size is large than when the final image size is small. Therefore, in order to reflect this fact, the area of the moving subject region is normalized to the image size.

When the area of the moving subject calculated by the above expression (Expression 1) is calculated as an image evaluation value, the evaluation value may be calculated by adding a weight according to the position of the image. A weight setting example will be described in the following (2).

(2) Exemplary Processing for Distance from Center of Screen of “Moving Subject” or “Another Subject with Large Parallax”

Next, exemplary processing will be described in which the weight is set according to the distance from the center of the screen of the “moving subject” or the “other subject with a large parallax” in the image evaluation process performed by the image evaluation unit 211.

In the following description, the exemplary processing for the “moving subject” will be described, but the same processing is also applicable to the “other subject with a large parallax”.

The image evaluation unit 211 generates the moving subject visualized image 360 shown in FIG. 16 using the images generated by the image synthesis unit 210 and the motion vector information generated by the movement amount detection unit 207, and performs the processing on the distance from the center of the screen of the “moving subject” by applying the moving subject visualized image 360.

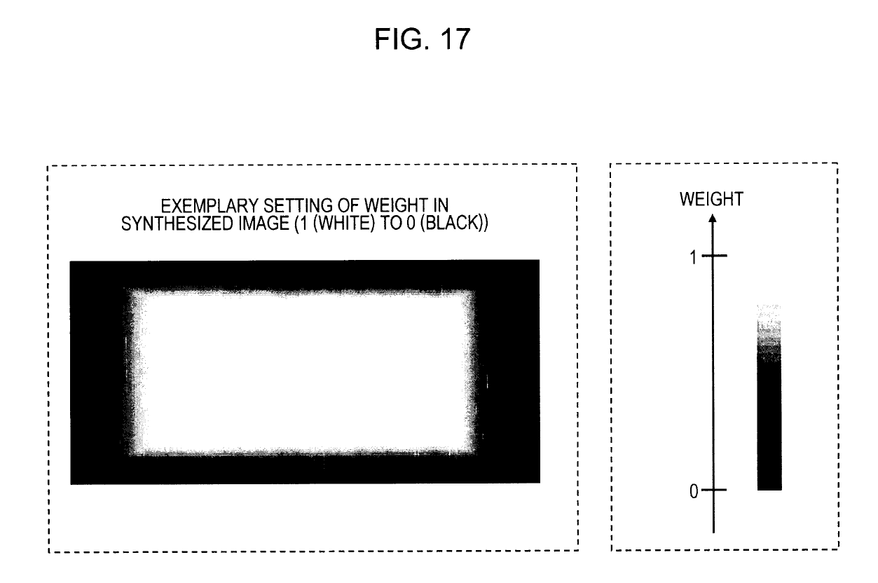

Utilizing the tendency that people usually view the middle portion of an image when people view the image, a weight may be added according to the positions of the images, the areas of the blocks detected as the moving subjects may be multiplied by a weight coefficient, and then the area of the moving subjects may be added. An example of the distribution of the weight coefficients (α=0 to 1) is shown in FIG. 17. FIG. 17 is a diagram illustrating an example in which the weight coefficient set in the synthesized image is shown as shading information. The weight coefficients are set such that the weight coefficients are increased in the middle portion of the synthesized image and the weight coefficients are decreased in the corners of the screen. The weight coefficients are set in the range, for example, of α=1 to 0.

For example, when the area (S) of the moving subject calculated by the above expression (Expression 1) is obtained as the image evaluation value, the evaluation value can be calculated by adding the weight according to the position of the image. The image evaluation value based on the area of the moving subject can be calculated according to Expression ΣαS by multiplying the weight coefficient: α=1 to 0 according to the detection position of the moving subject.

(3) Exemplary Processing of Calculating Movement Amount of “Moving Subject” or “Another Subject with Large Parallax” in Screen

Next, exemplary processing of calculating the movement amount of the “moving subject” or the “other subject with a large parallax” in the screen in the image evaluation process performed by the image evaluation unit 211 will be described.

In the following description, the exemplary processing on the “moving subject” will be described, but the same processing is also applicable to the “other subject with a large parallax”.

The image evaluation unit 211 calculates a vector additional value (L) obtained adding all of the lengths of the displayed real motion vectors in the moving subject visualized image 360 shown in FIG. 16, that is, “the movement amount additional value (L) which is an additional value of the movement amount corresponding to the vector length of the block correspondence difference vector with the size equal to or greater than the predetermined threshold value” by the blow expression (Expression 2). When this calculation process is performed, normalization is performed based on the image size of the synthesized image.

$$L = \frac{1}{w \cdot h} \sum ‖ v ‖ \qquad ( Expression 2 )$$

The vector additional value (L) of the real vector of the moving subject calculated by the above expression (Expression 2) is referred to as a moving subject movement amount.

In the above expression, w denotes an image horizontal size after synthesis, h denotes an image vertical size, and v denotes a real vector in the moving subject visualized image.

As in the case of the above-described expression (Expression 1), the reason for performing the normalization to the image sizes after the synthesis is to eliminate the dependency on the image sizes under the influence of the area of the moving subject and the moving subject on deterioration in image quality. The deterioration in the image quality of the moving subject is less when the final image size is large than when the final image size is small. Therefore, in order to reflect this fact, the area of the moving subject region is normalized to the image size.

When the moving subject movement amount calculated by the above expression (Expression 2), that is, “the movement amount additional value (L) which is an additional value of the movement amount corresponding to the vector length of the block correspondence difference vector with the size equal to or greater than the predetermined threshold value”, is calculated as the image evaluation value, as described above with reference to FIG. 17, the evaluation value may be calculated based on the moving subject movement amount by adding a weight according to the position of the image and multiplying the weight to the length of the vector detected as the moving subject.

For example, when the movement amount (L) of the moving subject calculated by the above expression (Expression 2) is obtained as the image evaluation value, the evaluation value can be calculated by adding the weight according to the position of the image. Based on the movement amount (L) of the moving subject corresponding to the image, that is, “the movement amount additional value (L) which is an additional value of the movement amount corresponding to the vector length of the block correspondence difference vector with the size equal to or greater than the predetermined threshold value”, the image evaluation value can be calculated by Expression ΣαL by multiplying the weight coefficient: α=1 to 0 according to the detection position of the moving subject.

The image evaluation unit 211 calculates the image evaluation value according to the various indexes in this manner and determines the properness of each synthesized image as the 3-dimensional image using the evaluation values.

In principle, when both the moving subject area and the moving subject movement amount have a large value, the image quality of the 3-dimensional image tends to be low. When both the moving subject area and the moving subject movement amount have a small value, the image quality of the 3-dimensional image tends to be high.

The image evaluation unit 211 calculates at least one index value of the moving subject area (S) and the moving subject movement amount (L) described above by the image unit supplied from the image synthesis unit 210, and determines the properness of the image as the 3-dimensional image from the index value.

The image evaluation unit 211 compares, for example, at least one index value of the moving subject area (S) and the moving subject movement amount (L) to the threshold value serving as the image evaluation determination information recorded in advance in the memory 209, and performs the final image properness determination.

The evaluation process is not limited to the two-level evaluation of the properness or the improperness. Instead, a plurality of threshold values may be provided to perform plural-level evaluation. The evaluation result is output to the output unit 204 immediately after the photographing to inform a user (photographer) of the evaluation result.

By supplying the image evaluation information, the user can confirm the image quality of the 3-dimensional image even when the user does not view the image on a 3-dimensional image display.

Moreover, when the evaluation is low, the user can make a decision to retry the photographing without recording the photographed images.

When the properness evaluation of the 3-dimensional image is performed, one index value may be used between the two indexes: the moving subject area (S) and the moving subject movement amount (L), that is, (1) the block area (S) of the block having the block correspondence difference vector with the size equal to or larger than the predetermined threshold value and (2) the movement amount additional value (L) which is an additional value of the movement amount corresponding to the vector length of the block correspondence difference vector with the size equal to or larger than the predetermined threshold value. However, the final index value obtained through combination of two indexes may be used. Moreover, as described above, the final properness evaluation value of the 3-dimensional image corresponding to the image may be calculated by applying the weight information [a].

For example, the image evaluation unit 211 calculates a 3-dimensional image properness evaluation value [A] as follows.

A=aΣ(α1)(S)+bΣ(α2)(L) (Expression 3)

In the above expression (Expression 3), S is a moving subject area, L is a moving subject movement amount, α1 is a weight coefficient (weight coefficient corresponding to the position of an image), α2 is a weight coefficient (weight coefficient corresponding to the position of an image), and a and b are weight coefficients (balance adjustment weight coefficients of the moving subject area (S) and the movement amount additional value (L)).

The parameters such as α1, α2, a, and b are stored in advance in the memory 209.

The image evaluation unit 211 compares the 3-dimensional image properness evaluation value [A] calculated by the above expression (Expression 3) to the image evaluation determination information (threshold value Th) stored in advance in the memory 209.

For example, when a determination expression A≧Th is satisfied in this comparison process, it is determined that the image is not proper as the 3-dimensional image. When the determination expression is not satisfied, it is determined that the image is proper as the 3-dimensional image.

The determination process using this determination expression is performed, for example, as a process corresponding to the determination process of step S112 in FIG. 11 in the image evaluation unit 211.

For example, the properness of the image as the 3-dimensional image may be determined by setting the values of the moving subject areas (S) as the x coordinate, setting the values of the moving subject movement amounts (L) as the y coordinate, and plotting the values as image evaluation data (x, y)=(S, L) on the xy plane.

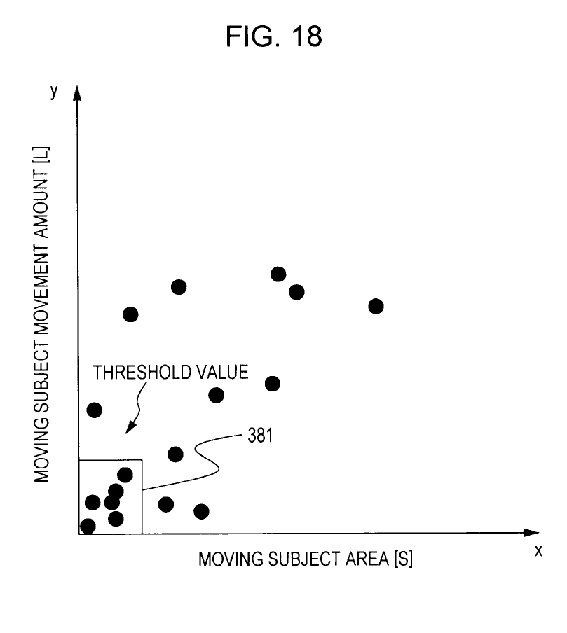

For example, as shown in FIG. 18, an image present within a region 381 surrounded by a straight line perpendicular to the x axis and a straight line perpendicular to the y axis is proper as the 3-dimensional image. That is, the image quality of the image is considered to be high.

FIG. 18 is a graph in which the horizontal axis (x axis) is the moving subject area (S), that is, (1) the block area (S) of the block having the block correspondence difference vector with the size equal to or greater than the predetermined threshold value and the vertical axis (y axis) is the moving subject movement amount (L), that is, (2) the movement amount additional value (L) which is an additional value of the movement amount corresponding to the vector length of the block correspondence difference vector with the size equal to or larger than the predetermined threshold value. Each set of image evaluation data (x, y)=(S, L) is plotted on the graph.

An image in which the image evaluation data (x, y)=(S, L) out of the region 381 is set is not proper as the 3-dimensional image. That is, the determination process of determining that the image quality is low may be performed. In FIG. 18, the region 381 has a rectangular shape. However, the region 381 may have an elliptical shape or a polynomial instead of the rectangular shape.

An evaluation function f(x, y) which uses the image evaluation data (x, y)=(S, L) as an input may be defined by another method and the output of this function may be used to determine the image quality of the 3D image. The calculation expression (Expression 3) of the above-described 3-dimensional image properness evaluation value [A], that is, A=aΣ(α1)(S)+bΣ(α2) (L) (Expression 3), also corresponds to one application example of the evaluation function f(x, y).

The coefficient of the evaluation function may be a fixed value recorded in the memory 209, but may be calculated by, for example, a learning process and may be updated sequentially. The learning process is performed, for example, off-line at any time, and the consequently obtained coefficients are sequentially supplied and updated for use.

The image evaluation unit 211 evaluates whether the images generated by the image synthesis unit 210, that is, the left-eye image and the right-eye image applied to display the 3-dimensional images, are proper as the 3-dimensional images. When it is determined that the images are not proper as the 3-dimensional images as the evaluation result, for example, the recording process of recording the images in the recording medium is suspended and a warning is output to a user. When the user makes a recording request, the recording process is performed. When the user makes no recording request, a process of stopping the recording process is performed.

As described above, the evaluation information is supplied from the image evaluation unit 211 to the recording unit 212, and the recording unit 212 also records the evaluation information as the attribute information (metadata) of the image recorded in a medium in the image. By using the record information, appropriate image correction can be rapidly performed in an information processing apparatus or an image processing apparatus, such as a PC, displaying 3-dimensional images.

The specific embodiment of the invention has hitherto been described in detail. However, it is apparent to those who are skilled in the art that the modification and alternations of the embodiment may occur within the scope of the invention without departing from the gist of the invention. That is, since the invention is disclosed according to the embodiment, the invention should not be construed as being limited. The claims of the invention are referred to determine the gist of the invention.

The series of processes described in the specification may be executed by hardware, software, or the combined configuration thereof. When the processes are executed by software, a program recording the processing order may be installed and executed in a memory embedded in a dedicated hardware computer or a program may be installed and executed in a general computer capable of various kinds of processes. For example, the program may be recorded in advance in a recording medium. As well as installing the program in a computer from the recording medium, the program may be received via a network such as a LAN (Local Area Network) or the Internet and may be installed in a recording medium such as a built-in hard disk.

The various kinds of processes described in the specification may be executed chronologically or may be executed in parallel or individually depending on the processing capacity of an apparatus executing the processes or as necessary. The system in the specification has a logical collective configuration of a plurality of apparatuses and is not limited to a case where the apparatuses with each configuration are included in the same chassis.

The present application contains subject matter related to that disclosed in Japanese Priority Patent Application JP 2010-024016 filed in the Japan Patent Office on Feb. 5, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
an image evaluation unit evaluating properness of synthesized images, which are applied to display 3-dimensional images generated through a process of connecting strip regions cut from images photographed at different positions, as the 3-dimensional images,
wherein the image evaluation unit
performs the process of evaluating the properness of the synthesized images as the 3-dimensional images through analysis of a block correspondence difference vector calculated by subtracting a global motion vector indicating movement of an entire image from a block motion vector which is a motion vector of a block unit of the synthesized images,
compares a predetermined threshold value to at least one of (1) a block area (S) of a block having the block correspondence difference vector with a size equal to or larger than the predetermined threshold value and (2) a movement amount additional value (L) which is an additional value of a movement amount corresponding to a vector length of the block correspondence difference vector with the size equal to or larger than the predetermined threshold value, and
performs a process of determining that the synthesized images are not proper as the 3-dimensional images, when the block area (S) is equal to or greater than a predetermined area threshold value or when the movement amount addition value (L) is equal to or greater than a predetermined movement amount threshold value.

2. The image processing apparatus according to claim 1,
wherein the image evaluation unit sets a weight according to a position of the block in the synthesized image, calculates the block area (S) or the movement amount additional value (L) by multiplying a weight coefficient larger in a middle portion of the image, and compares the result obtained by multiplying the weight coefficient to the threshold value.

3. The image processing apparatus according to claim 1 or 2,
wherein when calculating the block area (S) or the movement amount additional value (L), the image evaluation unit calculates the block area (S) or the movement amount additional value (L) by performing a normalization process based on an image size of the synthesized image, and compares the calculation result to the threshold value.

4. The image processing apparatus according to claim 1,
wherein the image evaluation unit calculates a properness evaluation value A of the 3-dimensional image by Expression A=aΣ(α1)(S)+bΣ(α2) (L),
where S is the block area, L is the movement amount additional value, α1 and α2 are the weight coefficient according to the position of the image, and a and b are balance adjustment weight coefficients of the block area (S) and the movement amount additional value (L).

5. The image processing apparatus according to claim 1,
wherein the image evaluation unit generates a visualized image in which a difference vector corresponding to the synthesized image is indicated by the block unit, and calculates the block area (S) and the movement amount additional value (L) by applying the visualized image.

6. The image processing apparatus according to claim 1, further comprising:
a movement amount detection unit inputting the photographed images and calculating the block motion vectors by a matching process for the photographed images with each other,
wherein the image evaluation unit calculates the block area (S) or the movement amount additional value (L) by applying the block motion vectors calculated by the movement amount detection unit.

7. The image processing apparatus according to any one of claims 1 to 6, further comprising:
an image synthesis unit inputting the plurality of images photographed at different positions and generating synthesized images by connecting strip areas cut from the respective images,
wherein the image synthesis unit generates a left-eye synthesized image applied to display a 3-dimensional image by a connection synthesis process of left-eye image strips set in each image and generates a right-eye synthesized image applied to display a 3-dimensional image by a connection synthesis process of right-eye image strips set in each image, and
wherein the image evaluation unit evaluates whether the synthesized images generated by the image synthesis unit are proper as the 3-dimensional images.

8. The image processing apparatus according to any one of claims 1 to 7, further comprising:
a control unit outputting a warning, when the image evaluation unit determines that the synthesized images are not proper as the 3-dimensional images.

9. The image processing apparatus according to claim 8,
wherein when the image evaluation unit determines that the synthesized images are not proper as the 3-dimensional images, the control unit suspends a recording process for the synthesized images in a recording medium and performs the recording process under a condition that a recording request is input from a user in response to the output of the warning.

10. An imaging apparatus comprising:
a lens unit applied to image photographing;
an imaging element performing photoelectrical conversion on a photographed image; and
an image processing unit performing the image processing according to any one of claims 1 to 9.

11. An image processing method performed by an image processing apparatus, comprising the step of:
evaluating, by an image evaluation unit, properness of synthesized images, which are applied to display 3-dimensional images generated through a process of connecting strip regions cut from images photographed at different positions, as the 3-dimensional images,
wherein in the step of evaluating the properness,
the process of evaluating the properness of the synthesized images as the 3-dimensional images is performed through analysis of a block correspondence difference vector calculated by subtracting a global motion vector indicating movement of an entire image from a block motion vector which is a motion vector of a block unit of the synthesized images,
a predetermined threshold value is compared to at least one of (1) a block area (S) of a block having the block correspondence difference vector with a size equal to or larger than the predetermined threshold value and (2) a movement amount additional value (L) which is an additional value of a movement amount corresponding to a vector length of the block correspondence difference vector with the size equal to or larger than the predetermined threshold value, and
a process of determining that the synthesized images are not proper as the 3-dimensional images is performed when the block area (S) is equal to or greater than a predetermined area threshold value or when the movement amount addition value (L) is equal to or greater than a predetermined movement amount threshold value.

12. A program causing an image processing apparatus to execute image processing, comprising the step of:
evaluating, by an image evaluation unit, properness of synthesized images, which are applied to display 3-dimensional images generated through a process of connecting strip regions cut from images photographed at different positions, as the 3-dimensional images,
wherein the step of evaluating the properness includes
performing the process of evaluating the properness of the synthesized images as the 3-dimensional images through analysis of a block correspondence difference vector calculated by subtracting a global motion vector indicating movement of an entire image from a block motion vector which is a motion vector of a block unit of the synthesized images, and
comparing a predetermined threshold value to at least one of (1) a block area (S) of a block having the block correspondence difference vector with a size equal to or larger than the predetermined threshold value and (2) a movement amount additional value (L) which is an additional value of a movement amount corresponding to a vector length of the block correspondence difference vector having the size equal to or larger than the predetermined threshold value, and
performing a process of determining that the synthesized images are not proper as the 3-dimensional images, when the block area (S) is equal to or greater than a predetermined area threshold value or when the movement amount addition value (L) is equal to or greater than a predetermined movement amount threshold value.
